(19) United States
(12) Patent Application Publication
(10) Pub. No.: US 2022/0278562 A1
(43) Pub. Date: Sep. 1, 2022

(54) Foreign Object Detection For Wireless Charging Systems

(71) Applicant: Stryker Corporation, Kalamazoo, MI (US)

(72) Inventors: Burton C. Judson, Kalamazoo, MI (US); Warren Guthrie, West Olive, MI (US); Timothy Cullen Davison, Spring Lake, MI (US); Stephen J. Reasoner, Kalamazoo, MI (US); John Gregory Videtich, Zeeland, MI (US)

(73) Assignee: Stryker Corporation, Kalamazoo, MI (US)

(21) Appl. No.: 17/633,052

(22) PCT Filed: Aug. 7, 2020
(86) PCT No.: PCT/US2020/045432

§ 371 Date: Feb. 4, 2022

Related U.S. Application Data
(60) Provisional application No. 62/884,092, filed on Aug. 7, 2019.

(51) Int. Cl. H02J 50/60; H02J 50/10; H02J 50/90; H02J 50/80

(52) U.S. Cl. CPC H02J 50/60; H02J 50/10; H02J 50/90; H02J 50/80; H02J 50/70

(57) ABSTRACT

Wireless charging systems and methods for detecting foreign objects proximate the wireless charging systems. A wireless charging system (10) includes a wirelessly chargeable battery (14) that receives power from a wireless charging device (16) when the wirelessly chargeable battery (14) is proximate the wireless charging device (16). The wireless charging device (16) determines an actual electrical consumption of the wireless charging system (10), and the wirelessly charging battery (14) measures a voltage induced in the wirelessly chargeable battery (14) by the wireless charging device (16). The wireless charging device (16), the wirelessly chargeable battery (14), or a combination of the two determines an expected electrical consumption of the wireless charging system (10) based on the measured voltage, and determines whether a foreign object (12) is proximate the wireless charging system (10) based on the expected and actual electrical consumptions.

### RELATED APPLICATIONS

The present application claims priority to and all the benefits of U.S. Provisional Patent Application No. 62/884,092 filed Aug. 7, 2019, the disclosure of which is hereby incorporated by reference herein in its entirety.

### BACKGROUND

When a conductive foreign object is positioned proximate the transmitting coil of a wireless charging system, the transmitting coil can induce a current in the foreign object that causes the foreign object to increase in temperature. The increased temperature of the foreign object can damage materials used in and around the wireless charging system and burn unexpecting users.

### SUMMARY

In one example, a system for detecting a foreign object proximate a wireless charging device includes a wirelessly chargeable battery. The wirelessly chargeable battery includes a receiving coil for receiving power from the wireless charging device when the receiving coil is proximate the wireless charging device, one or more battery cells, and an electrical load. The system also includes at least one controller configured to switch the wirelessly chargeable battery between a first configuration in which the receiving coil is coupled to the one or more battery cells for charging the one or more battery cells and is decoupled from the electrical load, and a second configuration in which the receiving coil is coupled to the electrical load for supplying power to the electrical load and is decoupled from the one or more battery cells. The at least one controller is also configured to measure a voltage induced in the wirelessly chargeable battery by the wireless charging device, determine, as a first electrical characteristic, an expected electrical loss of the wirelessly chargeable battery based on the measured voltage, and determine a second electrical characteristic of the electrical load when the wirelessly chargeable battery is in the second configuration. The at least controller is further configured to determine whether a foreign object is proximate the wireless charging device based on the first and second electrical characteristics.

In another example, a wireless charging device includes a transmitting coil for transmitting power to a wirelessly chargeable battery when the wirelessly chargeable battery is proximate the transmitting coil, a power supply coupled to the transmitting coil and configured to generate a power supply signal for powering the transmitting coil, and at least one controller. The at least one controller is configured to determine a first electrical characteristic of the power supply signal, determine, as a second electrical characteristic, an expected electrical loss of the wireless charging device, and determine whether a foreign object is proximate the wireless charging device based on the first and second electrical characteristics.

In a further example, a method for detecting a foreign object proximate a wireless charging system including a wireless charging device and a wirelessly chargeable battery including a receiving coil for receiving power from the wireless charging device when the receiving coil is proximate the wireless charging device, one or more battery cells, and an electrical load is provided. The method includes switching the wirelessly chargeable battery to a first configuration in which the receiving coil is coupled to the electrical load for supplying power to the electrical load and is decoupled from the one or more battery cells, measuring a voltage induced in the wirelessly chargeable battery by the wireless charging device, and determining, as a first electrical characteristic, an expected electrical loss of the wirelessly chargeable battery based on the measured voltage. The method also includes determining a second electrical characteristic of the electrical load when the wirelessly chargeable battery is in the first configuration, and determining whether a foreign object is proximate the wireless charging device based on the first and second electrical characteristics.

In a further example, a method for detecting a foreign object proximate a wireless charging device including a transmitting coil for transmitting power to a wirelessly chargeable battery when the wirelessly chargeable battery is proximate the transmitting coil and a power supply coupled to the transmitting coil and configured to generate a power supply signal for powering the transmitting coil is provided. The method includes determining a first electrical characteristic of the power supply signal, determining, as a second electrical characteristic, an expected electrical loss of the wireless charging device, and determining whether a foreign object is proximate the wireless charging device based on the first and second electrical characteristics.

In a further example, a wireless charging system for detecting foreign objects includes a wireless charging device and a wirelessly chargeable battery that receives power from wireless charging device when the wirelessly chargeable battery is proximate the wireless charging device. The wireless charging device includes a first controller configured to determine an actual electrical consumption of the wireless charging system. The wirelessly chargeable battery includes a second controller configured to measure a voltage induced in the wirelessly chargeable battery by the wireless charging device. The first controller, the second controller, or a combination of the first and second controllers, is configured to determine an expected electrical consumption of the wireless charging system based on the measured voltage, and determine whether a foreign object is proximate the wireless charging system based on the expected and actual electrical consumptions.

In a further example, a wirelessly chargeable battery for detecting foreign objects proximate a wireless charging system is provided. The wireless charging system includes a wirelessly chargeable battery and a wireless charging device that transmits power to the wirelessly chargeable battery when the wirelessly chargeable battery is proximate a wireless charging device. The wirelessly chargeable battery includes a controller configured to measure a voltage induced in the wirelessly chargeable battery by the wireless charging device, determine an expected electrical consumption of the wireless charging system based on the measured voltage, and determine whether a foreign object is proximate the wireless charging system based on the expected electrical consumption and an actual electrical consumption of the wireless charging system.

In a further example, a method for detecting foreign objects proximate a wireless charging system including a wireless charging device and a wirelessly chargeable battery that receives power from wireless charging device when the wirelessly chargeable battery is proximate the wireless charging device is provided. The method includes determining, by the wireless charging device, an actual electrical consumption of the wireless charging system, and measuring, by the wirelessly chargeable battery, a voltage induced in the wirelessly chargeable battery by the wireless charging device. The method further includes determining, by the wireless charging device, the wirelessly chargeable battery, or a combination of the wireless charging device and the wirelessly chargeable battery, an expected electrical consumption of the wireless charging system based on the measured voltage, and determining, by the wireless charging device, the wirelessly chargeable battery, or a combination of the wireless charging device and the wirelessly chargeable battery, whether a foreign object is proximate the wireless charging system based on the expected and actual electrical consumptions.

In a further example, a method for detecting foreign objects proximate a wireless charging system that includes a wirelessly chargeable battery and a wireless charging device that transmits power to the wirelessly chargeable battery when the wirelessly chargeable battery is proximate a wireless charging device is provided. The method includes measuring, by the wirelessly chargeable battery, a voltage induced in the wirelessly chargeable battery by the wireless charging device, determining, by the wirelessly chargeable battery, an expected electrical consumption of the wireless charging system based on the measured voltage, and determining, by the wirelessly chargeable battery, whether a foreign object is proximate the wireless charging system based on the expected electrical consumption and an actual electrical consumption of the wireless charging system.

In another example, a wireless charging system for detecting foreign objects includes a wirelessly chargeable battery and a wireless charging device having a transmitting coil for charging the wirelessly chargeable battery when the wirelessly chargeable battery is positioned proximate the transmitting coil. The wireless charging system further includes at least one controller configured to, responsive to the wirelessly chargeable battery being positioned a first distance from the transmitting coil of the wireless charging device, determine a first expected electrical consumption of the of the wireless charging system that corresponds to the first distance, and determine whether a foreign object is proximate the wireless charging device based on the first expected electrical consumption. The at least one controller is further configured to, responsive to the wirelessly chargeable battery being positioned a second distance from the transmitting coil of the wireless charging device that differs from the first distance, determine a second expected electrical consumption of the of the wireless charging system that corresponds to the second distance, and determine whether a foreign object is proximate the wireless charging device based on the second expected electrical consumption.

In a further example, a method for detecting a foreign object proximate a wireless charging system that includes a wirelessly chargeable battery and a wireless charging device having a transmitting coil for charging the wirelessly chargeable battery when the wirelessly chargeable battery is positioned proximate the transmitting coil is provided. The method includes, responsive to the wirelessly chargeable battery being positioned a first distance from the transmitting coil of the wireless charging device, determining a first expected electrical consumption of the wireless charging system that corresponds to the first distance, and determining whether a foreign object is proximate the wireless charging system based on the first expected electrical consumption. The method further includes, responsive to the wirelessly chargeable battery being positioned a second distance from the transmitting coil of the wireless charging device that differs from the first distance, determining a second expected electrical consumption of the wireless charging system that corresponds to the second distance, and determining whether a foreign object is proximate the wireless charging system based on the second expected electrical consumption.

In another example, a method for calibrating a wirelessly chargeable battery for detecting a foreign object proximate a wireless charging system, the wireless charging system including the wirelessly chargeable battery and a wireless charging device having a transmitting coil, and the wirelessly chargeable battery having a receiving coil, an electrical load coupled to the receiving coil, and a non-volatile storage device, is provided. The method includes positioning the wirelessly chargeable battery proximate the wireless charging device such that the receiving coil is positioned a first distance from the transmitting coil, and while the wirelessly chargeable battery is positioned proximate the wireless charging device such that the receiving coil is positioned a first distance from the transmitting coil, measuring a first voltage induced in the wirelessly chargeable battery by the wireless charging device, measuring a first electrical characteristic of a signal sourced to the electrical load and a first electrical characteristic of a power supply signal provided by the wireless charging device, and determining a first electrical loss of the wirelessly chargeable battery based on the first electrical characteristic of the electrical load, the first electrical characteristic of the power supply signal provided by the wireless charging device, and an expected electrical loss of the wireless charging device. The method further includes positioning the wirelessly chargeable battery proximate the wireless charging device such that the receiving coil is positioned a second distance from the transmitting coil that differs from the first distance, and while the wirelessly chargeable battery is positioned proximate the wireless charging device such that the receiving coil is positioned a second distance from the transmitting coil, measuring a second voltage induced in the wirelessly chargeable battery by the wireless charging device, measuring a second electrical characteristic of a signal sourced to the electrical load and a second electrical characteristic of the power supply signal provided by the wireless charging device, and determining a second electrical loss of the wirelessly chargeable battery based on the second electrical characteristic of the electrical load, the second electrical characteristic of the power supply signal provided by the wireless charging device, and the expected electrical loss of the wireless charging device. The method also includes generating calibration data for the wirelessly chargeable battery based on the first electrical loss of the wirelessly chargeable battery, the second electrical loss of the wirelessly chargeable battery, the first measured voltage, and the second measured voltage, and storing the calibration data in the non-volatile storage device of the wirelessly chargeable battery.

In a further example, a wireless charging system for detecting foreign objects includes a wireless charging device, a wirelessly chargeable battery having one or more battery cells that are configured to be charged from power received from the wireless charging device when the wirelessly chargeable battery is proximate the wireless charging device to charge the one or more battery cells, and at least one controller. The at least one controller is configured to initiate a charging cycle responsive to the wirelessly chargeable battery being positioned proximate the wireless charging device, monitor an electrical characteristic of a power supply signal provided by the wireless charging device during the charging cycle, and trigger a foreign object detection cycle based on the monitored electrical characteristic.

In another example, a method for detecting foreign objects proximate a wireless charging system including a wirelessly chargeable battery having one or more battery cells and a wireless charging device for charging the one or more battery cells of the wirelessly chargeable battery is provided. The method includes positioning the wirelessly chargeable battery proximate the wireless charging device, initiating a charging cycle, monitoring an electrical characteristic of a power supply signal provided by the wireless charging device during the charging cycle, and triggering a foreign object detection cycle based on the monitored electrical characteristic.

### BRIEF DESCRIPTION OF THE DRAWINGS

Advantages of the present disclosure will be readily appreciated, as the same becomes better understood by reference to the following detailed description, when considered in connection with the accompanying drawings. Non-limiting and non-exhaustive embodiments of the present disclosure are described with reference to the following figures, wherein like numerals refer to like parts throughout the various views unless otherwise specified.

FIG. 1 illustrates a wireless charging system for detecting a foreign object proximate the wireless charging system.

FIG. 2 illustrates components of the wireless charging system.

FIGS. 3A and 3B illustrate varying positions of a wirelessly chargeable battery relative to a wireless charging device of a wireless charging system.

FIG. 4 illustrates power consumption of a wireless charging system as a function of a distance between a wirelessly chargeable battery and a wireless charging device of the wireless charging system.

FIG. 5 illustrates a method for detecting a foreign object proximate a wireless charging system.

FIG. 6 illustrates calibration data for determining an expected power consumption of wirelessly chargeable battery of a wireless charging system.

FIG. 7 illustrates a power profile for charging a wirelessly chargeable battery of a wireless charging system.

FIG. 8 illustrates a charging device for charging multiple wirelessly chargeable batteries.

FIG. 9 illustrate a sterilizable container for containing wirelessly chargeable batteries.

### DETAILED DESCRIPTION

Reference throughout this specification to “one instance,” “an instance,” “one example,” or “an example” means that a particular feature, structure or characteristic described in connection with the instance of example is included in at least one instance of the present invention. Thus, appearances of the phrases “in one instance,” “in an instance,” “one example,” or “an example” in various places throughout this specification do not necessarily all refer to the same instance or example. Furthermore, the particular features, structures or characteristics may be combined in any suitable combinations and/or sub-combinations in one or more instances or examples. In addition, it is appreciated that the figures provided herewith are for explanation purposes to persons ordinarily skilled in the art and that the drawings are not necessarily drawn to scale.

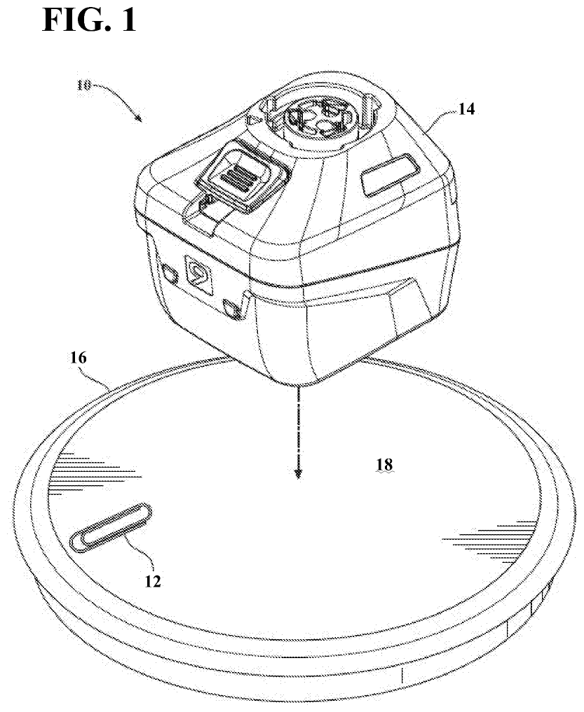

FIG. 1 illustrates a wireless charging system 10 configured to detect foreign objects 12 proximate the wireless charging system 10. When a foreign object 12, or more particularly a conductive foreign object 12, is accidently positioned proximate the wireless charging system 10, the wireless charging system 10 may induce an electrical current in the foreign object 12 that causes the foreign object 12 to heat. The heated foreign object 12 may then damage materials used in and around the wireless charging system 10, such as by melting adjacent plastic materials, and may burn users that contact the wireless charging system 10 and foreign object 12. The wireless charging system 10 may thus be configured to detect whether a foreign object 12 is proximate the wireless charging system 10 and, responsive to detecting such foreign object 12, disable charging operations and alert the user.

The wireless charging system 10 may include a wirelessly chargeable battery 14 and a wireless charging device 16. The wireless charging device 16 may include a charging surface 18. The wireless charging device 16 may be configured to charge the wirelessly chargeable battery 14 when the wirelessly chargeable battery 14 is positioned proximate the charging surface 18. In particular, the wireless charging device 16 may induce electrical signals in the wirelessly chargeable battery 14 that charges the wirelessly chargeable battery 14.

FIG. 1 also illustrates a foreign object 12 positioned proximate the charging surface 18. The foreign object 12 may include an electrically conductive material in which the wireless charging system 10 induces an electrical current, as described above. In the illustrated example, the foreign object 12 is a paperclip. As other non-limiting examples, the foreign object 12 may be a coin, key, or ring. The foreign object 12 may also be a medical object such as a foil-backed sterility indicator.

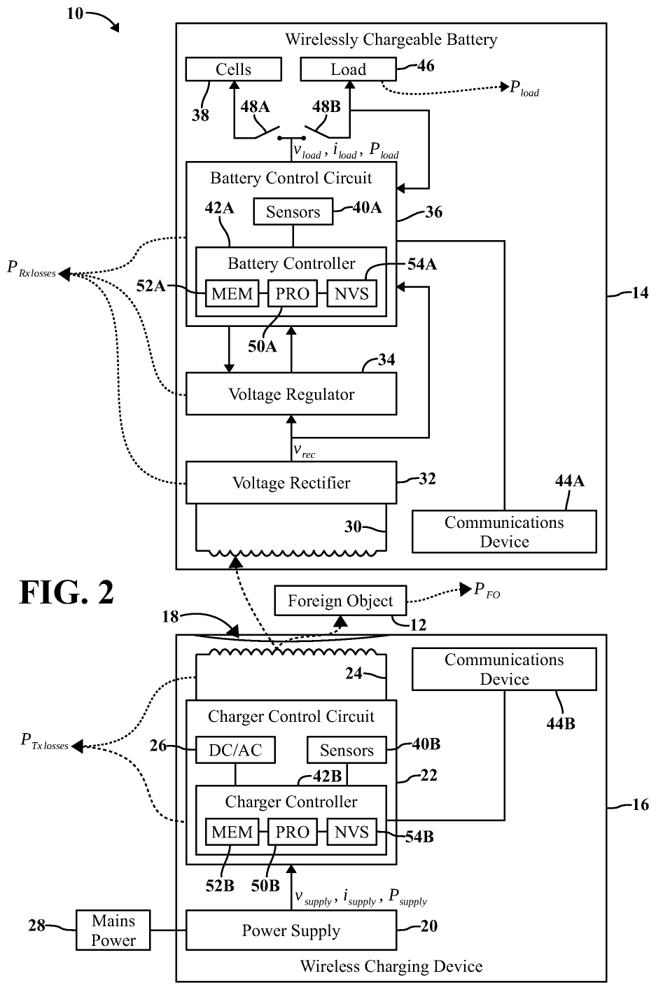

FIG. 2 illustrates components of the wireless charging system 10, or more particularly components of the wirelessly chargeable battery 14 and the wireless charging device 16. The wireless charging device 16 may include a power supply 20, a charger control circuit 22, and a transmitting coil 24. The charger control circuit 22 may include a DC/AC converter 26. During operation of the wireless charging system 10, the power supply 20 may receive a mains power signal from a mains power source 28, such as a wall outlet. The mains power signal may be an alternating current (AC) signal. The power supply 20 may be configured to output a power supply signal from the received mains power signal. In particular, the power supply 20 may be an AC/DC converter, and the power supply signal may be a direct current (DC) signal with a supply voltage v_{supply}, a supply current i_{supply}, and a supply power P_{supply}. The power supply 20 may be configured to source the power supply signal to the DC/AC converter 26 of the charger control circuit 22. The DC/AC converter 26 may then be configured to generate an AC signal across the transmitting coil 24 from the power supply signal. The AC signal across the transmitting coil 24 may generate an electromagnetic field that induces a corresponding AC signal in the receiving coil 30 of the wirelessly chargeable battery 14 when the wirelessly chargeable battery 14 is positioned proximate the charging surface 18.

In addition to the receiving coil 30, the wirelessly chargeable battery 14 may include a voltage rectifier 32, a voltage regulator 34, a battery control circuit 36, and one or more battery cells 38. When the receiving coil 30 of the wirelessly chargeable battery 14 is positioned proximate the charging surface 18, the electrical signal induced in the receiving coil 30 by the transmitting coil 24 may be supplied to the voltage rectifier 32. The voltage rectifier 32 may be configured to generate an incoming power signal from the signal induced in the receiving coil 30. The incoming power signal may be a DC signal with a received voltage v_{rec}. The voltage rectifier 32 may be configured to provide the incoming power signal to the voltage regulator 34, which may then be configured to output a load signal from the power received signal. The load signal may be a DC signal with a load voltage v_{load}, a load current i_{load}, and a load power P_{load}. When the wireless charging system 10 is operating in a charging mode, the battery control circuit 36 may be configured to route the load signal to the battery cells 38 to charge the battery cells 38.

Upon occurrence of a predefined event, the wireless charging system 10 may be configured to transition from the charging mode to a foreign object detection mode in which the wireless charging system 10 determines whether a foreign object 12 is proximate the charging surface 18 of the wireless charging device 16. The wireless charging system 10 may make this determination by identifying an expected electrical consumption of the wireless charging system 10 assuming no foreign object 12 is present, and comparing the expected electrical consumption to an actual electrical consumption of the wireless charging system 10 to determine whether a foreign object 12 is consuming power from the wireless charging system 10.

Electrical consumption of the wireless charging system 10 may be a function of the electrical losses of the wireless charging system 10 and an electrical consumption by a load of the wireless charging system 10, such as the battery cells 38. The electrical losses of the wireless charging system 10 may correspond to the power losses of the wireless charging system 10, which may include power dissipated by a foreign object 12 if present, and the electrical consumption by a load of the wireless charging system 10 may correspond to a power dissipated by the load of the wireless charging system 10. The electrical consumption of the wireless charging system 10 may thus correspond to the power supplied by the wireless charging system 10, or more particularly the power supplied by the power supply 20, and consumed by the wireless charging system 10 and by a foreign object 12 if proximate the wireless charging system 10.

Power consumption by the wireless charging system 10 may be attributed to a variety of sources. For instance, power may be dissipated by the intrinsic structures of the wireless charging device 16, such as the charger control circuit 22 and the transmitting coil 24. Power may also be dissipated by the intrinsic structures of the wirelessly chargeable battery 14, such as the voltage rectifier 32, the voltage regulator 34, and the battery control circuit 36. Power may further be dissipated by a load of the wirelessly chargeable battery 14, such as the battery cells 38. The power dissipated by the intrinsic structures of the wireless charging device 16 may be referred to herein as a power loss P_{Tx losses} of the wireless charging device 16, the power dissipated by the intrinsic structures of the wirelessly chargeable battery 14 may be referred to herein as a power loss P_{Rx losses} of the wirelessly chargeable battery 14, and the power consumed by the load of the of the wirelessly chargeable battery 14 may be referred to herein as P_{load}.

The power consumed by the wireless charging system 10 may be substantially equal the sum of P_{Tx losses}, P_{Rx losses}, and P_{load}. Assuming no foreign object 12 is positioned proximate the transmitting coil 24 of the wireless charging device 16, this sum may substantially equal the power supplied by the power supply 20, which may be referred to herein at P_{supply}. In other words, the following relationship may be true when no foreign object 12 is present:

0≈P_{supply}−P_{Tx losses}−P_{Rx losses}−P_{load}

However, when a foreign object 12 is positioned proximate the transmitting coil 24 of the wireless charging device 16, some of the power P_{supply} supplied by the power supply 20 may also be consumed by the foreign object 12. In particular, when a foreign object 12 including conductive material enters the magnetic field generated by the transmitting coil 24, the magnetic field may induce eddy currents in the conductive material. These currents may cause the foreign object 12 to dissipate power from the wireless charging system 10. The power dissipated by the foreign object 12 may be referred to herein as P_{FO}. Thus, when a foreign object 12 is present, the following relationship may be true:

P_{FO}≈P_{supply}−P_{Tx losses}−P_{Rx losses}−P_{load}

Accordingly, to determine whether a foreign object 12 is present, the wireless charging system 10 may be configured to determine a difference between the power P_{supply} supplied by the power supply 20, which may be referred to as an actual power consumption of the wireless charging system 10, and an expected power consumption of the wireless charging system 10 assuming no foreign object 12 is present. If the difference is less than a predefined threshold value, then the wireless charging system 10 may be configured to determine that no foreign object 12 is present. Alternatively, if the difference is greater than or equal to the predefined threshold value, then a foreign object 12 may be dissipating power P_{FO}, and the wireless charging system 10 may be configured to determine that a foreign object 12 is present.

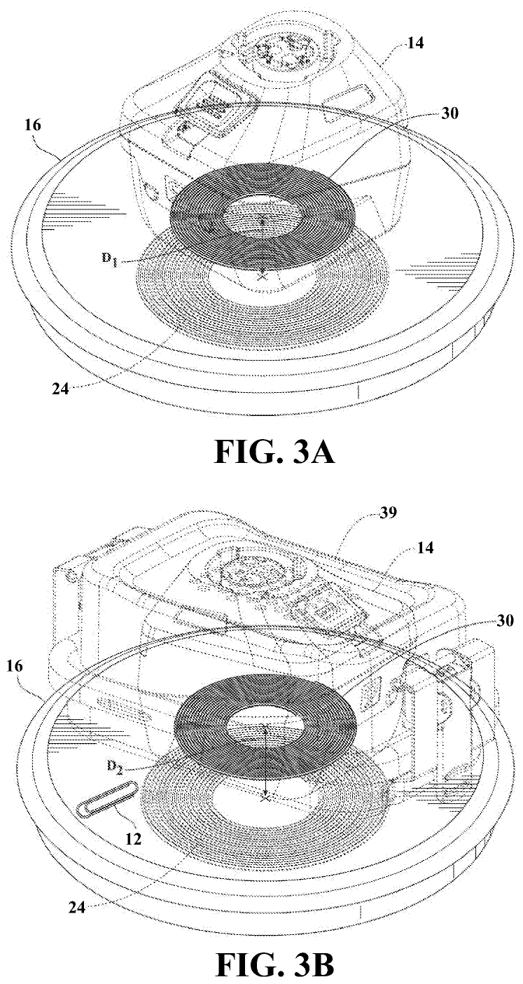

The power consumed by the wireless charging system 10, or more particularly by the wirelessly chargeable battery 14, may also be a function of the position of the receiving coil 30 of the wirelessly chargeable battery 14 relative to the transmitting coil 24 of the wireless charging device 16. In particular, the receiving coil 30 may be spaced various distances from the transmitting coil 24 and still receive power from the transmitting coil 24. For instance, referring to FIG. 3A, the wirelessly chargeable battery 14 may be disposed on the charging surface 18 of the wireless charging device 16 such that the receiving coil 30 is spaced at a distance D1 from the transmitting coil 24, where the distance D1 corresponds to a thickness of a housing of the wirelessly chargeable battery 14. As another example, referring to FIG. 3B, the wirelessly chargeable battery 14 may be disposed within a sterilizable container 39 that is then disposed on the charging surface 18 of the wireless charging device 16 such that the receiving coil 30 is spaced at a distance D2 from the transmitting coil 24, where the distance D2 includes both the thickness of the housing of the wirelessly chargeable battery 14 and the thickness of the sterilizable container 39, and is thus greater than the distance D1. As a further example, the wirelessly chargeable battery 14 may be disposed on the charging surface 18 of the wireless charging device 16 such that the receiving coil 30 is off center from the transmitting coil 24.

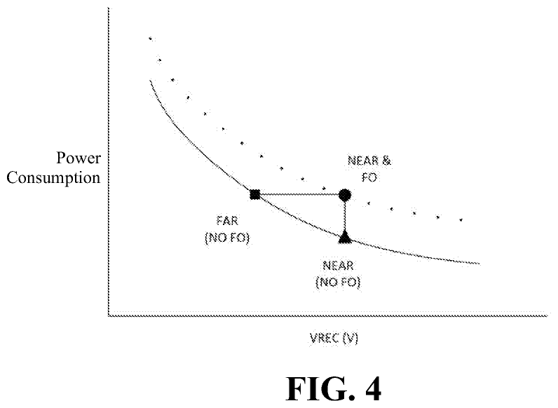

The power consumed by the wirelessly chargeable battery 14, and correspondingly the power consumed by the wireless charging system 10, may vary as a function of the distance between the receiving coil 30 of the wirelessly chargeable battery 14 and the transmitting coil 24 of the wireless charging device 16. For instance, FIG. 4 illustrates a graph with a solid line indicating power that may be consumed by the wireless charging system 10 as a function of the received voltage v_{rec} induced in the wirelessly chargeable battery 14 by the wireless charging device 16 when no foreign object 12 is proximate the wireless charging device 16. As shown in the illustrated example, the greater the distance between the receiving coil 30 and the transmitting coil 24, the less the received voltage v_{rec} that may be induced in the wirelessly chargeable battery 14 by the wireless charging device 16, and correspondingly, the greater the power that may be consumed by the wireless charging system 10.

FIG. 4 also illustrates a dotted line indicating power of the wireless charging system 10 that may be consumed when a foreign object 12 is proximate the wireless charging device 16 as a function of the received voltage v_{rec} induced in the wirelessly chargeable battery 14 by the wireless charging device 16. As shown in the illustrated example, the power of the wireless charging system 10 that may be consumed when a foreign object 12 is proximate the wireless charging device 16 may be similar to the power of the wireless charging system 10 that may be consumed when a foreign object 12 is not present but the distance between the receiving coil 30 and the transmitting coil 24 is increased. This situation may be represented by the examples illustrated in FIGS. 3A and 3B.

The wireless charging system 10 may be configured to distinguish between an instance where the wirelessly chargeable battery 14 is disposed at a distance from the wireless charging device 16 without a foreign object 12 and an instance where the wirelessly chargeable battery 14 is disposed at a further distance from the wireless charging device 16 and a foreign object 12 is proximate the wireless charging device 16, even if the consumed power of the wireless charging system 10 is similar in both instances. More particularly, the wireless charging system 10 may be configured to determine an expected power consumption of the wireless charging system 10 based on electrical characteristics of the wireless charging system 10 measured at run time and predefined calibration data specific to the wireless charging system 10. The expected power consumption of the wireless charging system 10 may assume that no foreign object 12 is proximate the wireless charging device 16. The wireless charging system 10 may also be configured to determine an actual power consumption of the wireless charging system 10 based on electrical characteristics of the wireless charging system 10 measured at run time. For instance, the actual power consumption may correspond to the power P_{supply} provided by the power supply 20. While the expected power consumption of the wireless charging system 10 may not include any power P_{FO} lost to a foreign object 12, because the supply current i_{supply} increases when power P_{FO} is dissipated through the foreign object 12, the actual power consumption determined for the wireless charging system 10 may increase when power P_{FO} is dissipated through a foreign object 12. Accordingly, unlike the expected power consumption, the actual power consumption may include power P_{FO} lost to a foreign object 12. Hence, if the actual power consumption differs from the expected power consumption by more than a predefined threshold value, then the wireless charging system 10 may be configured to determine that a foreign object 12 is proximate the wireless charging device 16.

Instead of power consumption, the electrical consumptions identified by the wireless charging system 10 to determine whether a foreign object 12 is proximate the wireless charging device 16 may be defined by currents through the wireless charging system 10. In particular, because power dissipated by an object is a function of voltage across the object and current through the object, and voltage across the wireless charging system 10 may remain substantially constant throughout a given foreign object detection cycle, the wireless charging system 10 may be configured to determine an expected current through the wireless charging system 10 assuming no foreign object 12 is present, and to compare the expected current to an actual current supplied to the wireless charging system 10 to determine whether a foreign object 12 is proximate the wireless charging device 16. The actual current supplied to the wireless charging system 10 may correspond to the supply current i_{supply}. If the actual current differs from the expected current by more than a predefined threshold value, then the wireless charging system 10 may be configured to determine that a foreign object 12 is proximate the wireless charging device 16. Thus, while power supplied and consumed by the wireless charging system 10 may be referenced in the examples below to detect the presence of a foreign object 12, it will be understood that electrical current supplied and consumed by the wireless charging system 10 may alternatively be used.

The wirelessly chargeable battery 14 and the wireless charging device 16 may each include sensors 40 and a controller 42 for determining whether a foreign object 12 is proximate the wireless charging device 16. The sensors 40A of the wirelessly chargeable battery 14 may be configured to generate data indicative of electrical characteristics of the electrical signals in the wirelessly chargeable battery 14, and the sensors 40B of the wireless charging device 16 may be configured to generate data indicative of electrical characteristics of the electrical signals in the and wireless charging device 16. As one non-limiting example, the sensors 40 of each of the wirelessly chargeable battery 14 and the wireless charging device 16 may include a voltage sensor and a current sensor.

The controllers 42 may be configured to determine whether a foreign object 12 is proximate the wireless charging device 16 based on the electrical characteristics indicated by the sensor data generated by the sensors 40. In particular, the controllers 42 may be configured determine an expected electrical consumption of the wireless charging system 10 based on the sensor data, and to determine whether a foreign object 12 is proximate the wireless charging device 16 based on the expected electrical consumption and an actual electrical consumption of the wireless charging system 10, as described herein.

The electrical consumption of the wireless charging system 10 may be a function of current through the wireless charging system 10, which may include the current through the battery cells 38. Because the impedance of the battery cells 38 may vary depending on their level of charge, determining an expected electrical consumption of the wireless charging system 10 as a function of the current through the battery cells 38 when the battery cells 38 are being charged may complicate the determination and lead to inaccurate results. Accordingly, the wirelessly chargeable battery 14 may also include an electrical load 46 for performing foreign object detection. The electrical load 46 may have a fixed, predetermined impedance. In some instances, the electrical load 46 may represent an impedance of the battery cells 38 when the battery cells 38 are fully charged or substantially fully charged. In other words, the electrical load 46 may have an impedance sized to dissipate an amount of power substantially equal to a maximum amount of power that may be provided to the battery cells 38 during charging of the battery cells 38, which may occur when the battery cells 38 are nearly fully charged. For example, the electrical load 46 may include one or more resistors sized to provide a combined resistance of 8.3 ohms and consume about 15 watts of power.

The wirelessly chargeable battery 14 may include one or more switches 48, such as a switch 48A between the voltage regulator 34 and the battery cells 38 and a switch 48B between the voltage regulator 34 and the electrical load 46, for switching between a charging configuration in which the receiving coil 30 is coupled to the battery cells 38 for charging the battery cells 38, and a foreign object detection configuration in which the receiving coil 30 is coupled to the electrical load 46 for supplying power to the electrical load 46. The battery controller 42A may be configured to switch the wirelessly chargeable battery 42A between these configurations. In particular, when a charging cycle is triggered, the battery controller 42A may be configured to engage the switch 48A and disengage the switch 48B if engaged so that the receiving coil 30 is coupled to the battery cells 38 and decoupled from the electrical load 46. As a result, power from the receiving coil 30 may be supplied to and charge the battery cells 38. When a foreign object detection cycle is triggered, the battery controller 42A may be configured to disengage the switch 48A if engaged and engage the switch 48B so that the receiving coil 30 is coupled to the electrical load 46 and decoupled from the battery cells 38. As a result, power from the receiving coil 30 may be supplied to the electrical load 46. When neither a charging cycle nor foreign object detection cycle is being performed by the wireless charging system 10, such as when the wirelessly chargeable battery 14 is not proximate the wireless charging device 16, or a foreign object 12 has been detected, the battery controller 42A may be configured disengage both the switches 48A, 48B so neither the battery cells 38 nor the electrical load 46 receives power from the receiving coil 30. Responsive to a charging cycle or foreign object detection cycle being subsequently triggered, the battery controller 42A may be configured to engage the switch 48A or switch 48B respectively.

Alternatively to the electrical load 46 having an impedance of the battery cells 38 when the battery cells 38 are fully charged or substantially fully charged, the electrical load 46 may be configured with an impedance for minimizing an amount of power transmitted by the transmitting coil 24 to the receiving coil 30 during each foreign object detection cycle. In other words, the electrical load 46 may be configured with a relatively large impedance, such as about 56 ohms, which may consume about 2 watts of power during a given foreign object detection cycle. The smaller amount of consumed power may enable the wireless charging system 10 to detect smaller variations from the expected electrical consumption, lending to increased detection of foreign objects 12.

Each controller 42 of the wireless charging system 10 may include a processor 50, memory 52, and non-volatile storage 54. The processor 50 may include one or more devices selected from microprocessors, micro-controllers, digital signal processors, microcomputers, central processing units, field programmable gate arrays, programmable logic devices, state machines, logic circuits, analog circuits, digital circuits, and/or any other devices that manipulate signals (analog or digital) based on operational instructions stored in the non-volatile storage 54 and read into the memory 52. The memory 52 may include a single memory device or a plurality of memory devices including, but not limited to, read-only memory (ROM), random access memory (RAM), volatile memory, non-volatile memory, static random access memory (SRAM), dynamic random access memory (DRAM), flash memory, cache memory, and/or any other device capable of storing information. The non-volatile storage 54 may include one or more persistent data storage devices such as a hard drive, optical drive, tape drive, non-volatile solid state device, and/or any other device capable of persistently storing information.

The processor 50 of each controller 42 may be programmed to implement the functions, features, processes, methods, and modules of the controller 42 described herein. In particular, the processor 50 may operate under control of software embodied by computer-executable instructions residing in the non-volatile storage 54. The computer-executable instructions may be compiled or interpreted from a variety of programming languages and/or technologies, including, without limitation, and either alone or in combination, Java, C, C++, C#, Objective C, Fortran, Pascal, Java Script, Python, Perl, and PL/SQL. During operation, the processor 50 may be configured to read the computer-executable instructions into memory 52 and then execute the computer-executable instructions. The computer-executable instructions may be configured, upon execution of the processor 50, to cause the processor 50 to implement the functions, features, processes, methods, and modules of the controller 42 describe herein.

For instance, the computer-executable instructions residing in the non-volatile storages 54 of the controllers 42 may be configured, upon execution by the processors 50 of the controllers 42, to cause the processors 50 of to determine whether a foreign object 12 is proximate the wireless charging device 16 based on electrical characteristics measured by the controllers 42, such as using the sensors 40. In particular, the computer-executable instructions of the battery controller 42A may be configured upon execution to cause processor 50A to determine electrical characteristics corresponding to electrical signals in the wirelessly chargeable battery 14. The electrical characteristics determined by the battery controller 42A may indicate an expected electrical consumption of the wirelessly chargeable battery 14. Similarly, the computer-executable instructions of the charger controller 42B may be configured upon execution to cause the processor 50B to determine electrical characteristics corresponding to electrical signals in the wireless charging device 16. The electrical characteristics determined by the charger controller 42B may indicate an expected electrical consumption of the wireless charging device 16, and may indicate a power supplied by the wireless charging system 10.

The computer-executable instructions of the controllers 42 may then be configured upon execution to cause the processors 50 to consolidate data generated based on the determined electrical characteristics at one of the controllers 42. Responsively, the computer-executable instructions of one controller 42 may be configured upon execution to cause the processor 50 of this controller 42 to determine whether a foreign object 12 is proximate the wireless charging device 16 based on the consolidated data as described herein.

To facilitate communication of data between the controllers 42, each of the wirelessly chargeable battery 14 and wireless charging device 16 may include a communications device 44. In some examples, the communications devices 44 may be wireless communications devices configured to support wireless communication between the battery controller 42A and the charger controller 42B when the wirelessly chargeable battery 14 is positioned proximate the wireless charging device 16. For example and without limitation, the communication devices 44 may each be configured to wirelessly transmit and receive data using IR, NFC, RFID, ZigBee, Bluetooth, and/or Wi-Fi protocols.

In addition to software programs embodied by computer-executable instructions, the non-volatile storage 54 of each controller 42 may also store data supporting the functions, features, processes, methods, and modules of the controller 42 described herein. For instance, the non-volatile storage 54 of each controller 42 may store calibration data that enables the controller 42 to determine expected electrical consumptions. Each controller 42 may be configured to query the calibration data stored in the non-volatile storage 54 of the controller 42 to facilitate determining the presence of a foreign object 12.

As one non-limiting example, the non-volatile storage 54A may include calibration data indicating an expected electrical loss of the wirelessly chargeable battery 14 as a function of the voltage v_{rec} induced in the wirelessly chargeable battery 14 and measured by the battery controller 42A using the sensors 40A. The expected electrical loss of the wirelessly chargeable battery 14 may be an expected power loss P_{Rx losses} of the wirelessly chargeable battery 14 or a current through the wirelessly chargeable battery 14 that contributes to the expected power loss P_{Rx losses} of the wirelessly chargeable battery 14, as described above. The battery controller 42A may be configured to determine an expected electrical consumption of the wirelessly chargeable battery 14 based on the expected electrical loss, and to determine an expected electrical consumption of the wireless charging system 10 based on the expected electrical consumption of the wirelessly chargeable battery 14.

As a further non-limiting example, the non-volatile storage 54B of the charger controller 42B may store calibration data indicating an expected electrical loss of the wireless charging device 16 when a wirelessly chargeable battery 14 is positioned adjacent the charging surface 18 of the wireless charging device 16. The expected electrical loss of the wireless charging device 16 may be an expected power loss P_{Tx losses} of the wireless charging device 16 or a current through the wireless charging device 16 that contributes to the expected power loss P_{Tx losses} of the wireless charging device 16, as described above. The charger controller 42B may be configured to determine an expected electrical consumption of the wireless charging device 16 based on the expected electrical loss of the wireless charging device 16, and to determine an expected electrical consumption of the wireless charging system 10 based on the expected electrical consumption of the wireless charging device 16.

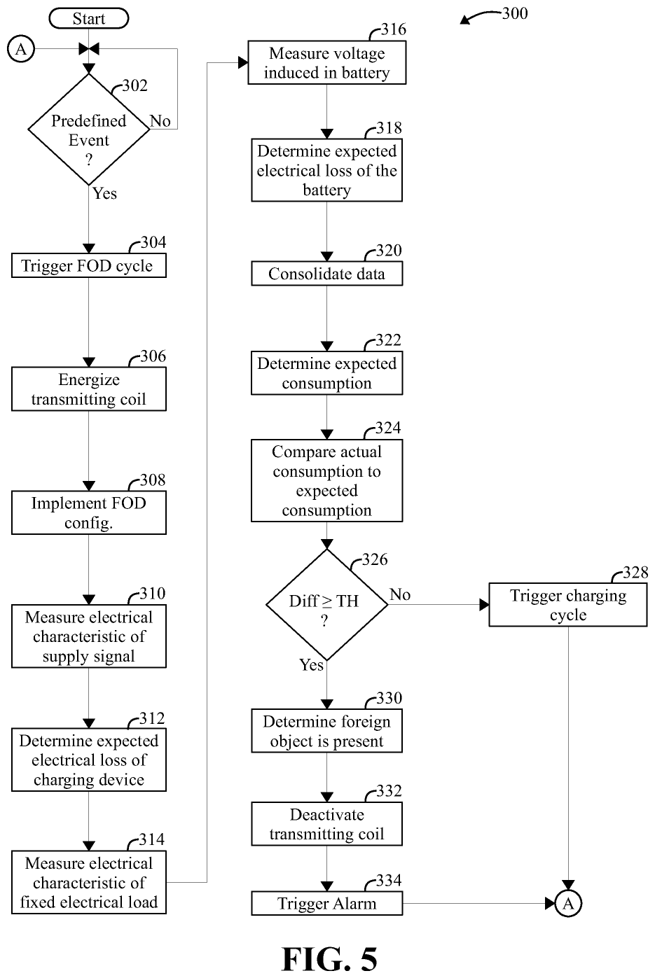

FIG. 5 illustrates a method 300 for determining whether a foreign object 12 is proximate the wireless charging device 16. The method 300 may be implemented by the controllers 42. In particular, the battery controller 42A may be configured to implement one or more blocks of the method 300, and the charger controller 42B may be configured to implement one or more other blocks of the method 300.

In block 302, a determination may be made of whether a predefined event has occurred. Specifically, at least one the controllers 42, such as the charger controller 42B, may be configured to monitor for occurrence of one or more predefined events. Responsive to detecting occurrence of one of the one or more predefined events, a controller 42 may be configured to trigger a foreign object detection cycle.

One of the predefined events monitored for by at least one of the controllers 42 may be the wirelessly chargeable battery 14 being positioned proximate the charging surface 18 of the wireless charging device 16. In one example, the charger controller 42B may be configured to determine whether this predefined event has occurred based on the supply current i_{supply} of the power supply signal output from the power supply 20. More particularly, the charger controller 42B may be configured to periodically scan for presence of a wirelessly chargeable battery 14 proximate the wireless charging device 16 by causing the DC/AC converter 26 to periodically output an AC signal across the transmitting coil 24, and then measuring the supply current i_{supply} of the power supply signal output by the power supply 20. When a wirelessly chargeable battery 14 is positioned proximate the charging surface 18 of the wireless charging device 16, the output power supply signal may induce electrical energy in the receiving coil 30, and correspondingly, the supply current i_{supply} of the power supply signal may increase. Accordingly, the charger controller 42B may be configured to determine whether a wirelessly chargeable battery 14 has become proximate the charging surface 18 of the wireless charging device 16 by being configured to determine whether the measured supply current i_{supply} increases to a value greater than a predefined threshold value. Responsive to determining that the measured supply current i_{supply} has become greater than the predefined threshold value, the charger controller 42B may be configured to determine that a wirelessly chargeable battery 14 has been positioned proximate the charging surface 18 of the wireless charging device 16.

As a further example, at least one of the controllers 42 may be configured to determine whether a wirelessly chargeable battery 14 has been positioned adjacent the charging surface 18 of the wireless charging device 16 using the communication devices 44. In particular, one of the communications devices 44, which may be designated as the signaling communications device 44, may be configured to periodically advertise a beacon signal to be received by the other communications device 44, which may be designated as the acknowledging communications device 44, when the wirelessly chargeable battery 14 is positioned adjacent the charging surface 18 of the wireless charging device 16. In one example, the communications device 44B may be configured as the signaling communications device 44, and the communications device 44A may be configured as the acknowledging communications device 44. Responsive to the wirelessly chargeable battery 14 being positioned adjacent the charging surface 18 of the wireless charging device 16, the acknowledging communications device 44 may receive the beacon signal, and responsively communicate an acknowledgement signal to the signaling communications device 44. The signaling communications device 44 may then communicate a signal to the controller 42 coupled to the signaling communications device 44 to indicate that a wirelessly chargeable battery 14 is now adjacent the charging surface 18 of the wireless charging device 16.

In some instances, responsive to determining that a wirelessly chargeable battery 14 has been positioned adjacent the charging surface 18 of the wireless charging device 16, at least one of the controllers 42 may be configured to verify that wirelessly chargeable battery 14 and wireless charging device 16 are compatible. For instance, the non-volatile storage 54 of each controller 42 may store authentication data. One of the controllers 42, such as the charger controller 42B, may be configured to communicate its stored authentication data to the other controller 42 over the communications devices 44. The other controller 42 then be configured to determine whether the received authentication data corresponds to the authentication data stored in its non-volatile storage 54. Responsive to determining that the received authentication data corresponds to its authentication data, the other controller 42 may be configured to determine that the wirelessly chargeable battery 14 and wireless charging device 16 are compatible.

Responsive to determining occurrence of a predefined event, such as a wirelessly chargeable battery 14 being positioned adjacent the charging surface 18 of the wireless charging device 16 (“Yes” branch of block 302), and/or to authenticating use of the wirelessly chargeable battery 14 with the wireless charging device 16, in block 304, a foreign object detection cycle may be triggered. To this end, the controller 42 that determined occurrence of the predetermined event and/or authenticated use of the wirelessly chargeable battery 14 with the wireless charging device 16 may be configured to communicate a signal to the other controller 42 over the communications devices 44 that instructs the other controller 42 to begin implementing a foreign object detection cycle.

In block 306, the transmitting coil 24 may be energized to transmit power to the receiving coil 30 of the wirelessly chargeable battery 14. In particular, the charger controller 42B may be configured to cause the DC/AC converter 26 to generate an AC signal across the transmitting coil 24 from a supply power signal received from the power supply 20. The AC signal across the transmitting coil 24 may generate an electromagnetic field that induces a corresponding AC signal in the receiving coil 30.

In block 308, a foreign object detection configuration may be implemented within the wirelessly chargeable battery 14. In particular, the battery controller 42A may be configured to engage the switch 48B and disengage the switch 48A if engaged so that the receiving coil 30 is coupled to the electrical load 46 and decoupled from the battery cells 38. In this way, a portion of the power provided to the wirelessly chargeable battery 14 from the wireless charging device 16 may be supplied to and dissipated by the electrical load 46.

In block 310, an electrical characteristic of the power supply signal output by the power supply 20 may be measured. As examples, the measured electrical characteristic may be the supply power p_{supply} provided by the power supply signal or the supply current i_{supply}. The measured electrical characteristic of the power supply signal may be used as an actual electrical consumption of the wireless charging system 10, as described above. The charger controller 42B may be configured to determine the electrical characteristic of the power supply signal using the sensors 40B.

In block 312, an expected electrical loss of the wireless charging device 16 may be determined. The expected electrical loss of the wireless charging device 16 may be treated as a constant value, and may thus be measured and saved as calibration data in the non-volatile storage 54B of the charger controller 42B prior to distribution. In particular, after manufacturing of the wireless charging device 16 is completed and without a foreign object 12 or a wirelessly chargeable battery 14 being proximate the charging surface 18 of the wireless charging device 16, a technician may cause the power supply 20 to generate a power supply signal that in turn causes an AC signal to develop across the transmitting coil 24. Because no foreign object 12 and no wirelessly chargeable battery 14 is present, the power supply signal during this operation may correspond to the electrical loss of the wireless charging device 16. In other words, the power p_{supply} of the power supply signal, as indicated by the product of the supply current i_{supply} and supply voltage v_{supply}, or simply the supply current i_{supply}, may be measured and used as the expected electrical loss of the wireless charging device 16. Responsive to determining the electrical loss of the wireless charging device 16 in this manner, calibration data indicating the determined electrical loss of the wireless charging device 106 may be stored in the non-volatile storage 54B of the charger controller 42B. Later, in block 312, the charger controller 42B may be configured to determine the expected electrical loss of the wireless charging device 16 by reading the calibration from the non-volatile storage 54B.

In block 314, an electrical characteristic of the electrical load 46 may be determined. For instance, the battery controller 42A may be configured to measure the electrical characteristic of the electrical load 46 using the sensors 40A. More particularly, the battery controller 42A may be configured to measure a power P_{load} dissipated by the electrical load 46 as the determined electrical characteristic of the fixed electrical load 46, such as by measuring the load voltage v_{load} and the load current i_{load} and multiplying these two values together, or by measuring the load voltage v_{load} and dividing this value squared by the impedance of the electrical load 46. Alternatively, the battery controller 42A may be configured to measure and use the load current i_{load} as the determined electrical characteristic of the electrical load 46. Alternatively, because the voltage from the voltage regulator 34 may be substantially constant during each foreign object detection cycle, such as 11.2 volts, the determined electrical characteristic of the electrical load 46 may remain substantially constant during each foreign object detection cycle. Accordingly, the electrical characteristic, such as the power P_{load} or the current i_{load}, may be predetermined and stored as calibration data in the non-volatile storage 54A of the battery controller 42A, such as prior to distribution of the wirelessly chargeable battery 14. Thereafter, responsive to a foreign object detection cycle being triggered in the wirelessly chargeable battery 14, the battery controller 42A may be configured to determine the electrical characteristic of the electrical load 46 by reading the electrical characteristic from the calibration data stored in the non-volatile storage 54A.

In block 316, a voltage induced in the wirelessly chargeable battery 14 by the wireless charging device 16 may be measured. More particularly, the AC signal generated across the receiving coil 30 may be supplied to the voltage rectifier 32, which in turn may output an incoming power signal with a received voltage v_{rec}. The battery controller 42A may be configured to measure the received voltage v_{rec} using the sensors 40A. Alternatively, the battery controller 42A may be configured to measure and use the AC voltage across the receiving coil 30 as the measured voltage induced in the wirelessly chargeable battery 14 by the wireless charging device 16.

In block 318, an expected electrical loss of the wirelessly chargeable battery 14 may be determined based on the measured voltage, such as the received voltage v_{rec}. As previously described, positional deviations of the wirelessly chargeable battery 14 relative to the wireless charging device 16 may cause different voltages to be induced in the wirelessly chargeable battery 14, and correspondingly, may cause the wirelessly chargeable battery 14 to exhibit different electrical losses. Accordingly, the battery controller 42A may be configured to determine an expected electrical loss of the wirelessly chargeable battery 14 based on the measured induced voltage, such as the received voltage v_{rec}. The determined expected electrical loss of the wirelessly chargeable battery 14 may correspond to electrical losses of the wirelessly chargeable battery 14 that have previously occurred when the measured voltage is induced in the wirelessly chargeable battery 14 and no foreign object 12 is present.

More specifically, the non-volatile storage 54A of the battery controller 42A may store calibration data indicating varying expected electrical losses of the wirelessly chargeable battery 14 that correspond to varying positions of the wirelessly chargeable battery 14 relative to a wireless charging device 16 when a foreign object 12 is not present. Each of the varying expected electrical losses may be associated within the calibration data with a different voltage that, when induced in the wirelessly chargeable battery 14 by the wireless charging device 16 while a foreign object 12 is not present, may cause the wirelessly chargeable battery 14 to exhibit an electrical loss corresponding to the expected electrical loss associated with the voltage. The battery controller 42A may thus be configured to determine the expected electrical loss of the wirelessly chargeable battery 14 based on the measured voltage induced in the wirelessly chargeable battery 14 by being configured to determine the expected electrical loss indicated in the calibration data that is associated with the measured induced voltage within the calibration data.

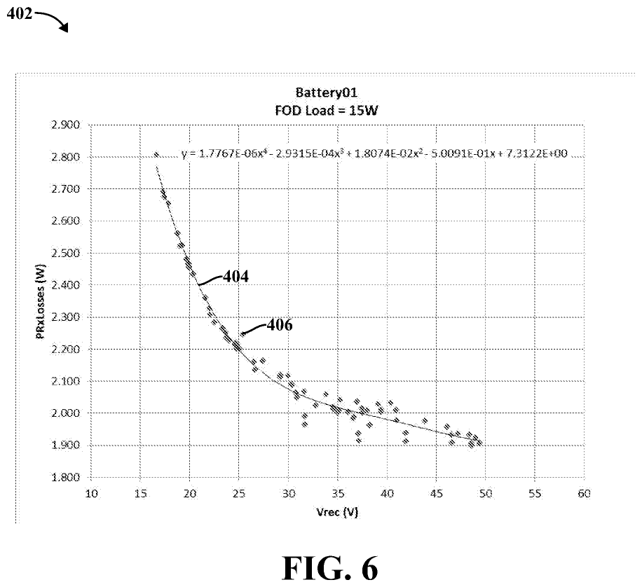

FIG. 6 illustrates a graph 402 that may be represented by the calibration data stored in the non-volatile memory 52A of the battery controller 42A to determine the expected electrical loss of the wirelessly chargeable battery 14. The Y axis of the graph represents varying expected power loses of the wirelessly chargeable battery 14 when no foreign object 12 is present, and the X axis represents varying voltages that may be induced in the wirelessly chargeable battery 14 by the wireless charging device 16 and measured by the battery controller 42A in block 316. According to the graph 402, the relationship between the expected power loss of the wirelessly chargeable battery 14 when no foreign object 12 is present and the measured voltage induced in the wirelessly chargeable battery 14 may be defined by a function 404, which may be a non-linear decreasing function. In other words, assuming no foreign object 12 is present, as the distance between the wirelessly chargeable battery 14 and the wireless charging device 16 decreases, which may cause an increase in the received voltage v_{rec} induced in the wirelessly chargeable battery 14, the expected electrical loss of the wirelessly chargeable battery 14 may decrease.

In alternative examples, the relationship between the expected power loss of the wirelessly chargeable battery 14 when no foreign object 12 is present and the measured voltage induced in the wirelessly chargeable battery 14 may be defined by U-shaped function 404. More particularly, as the receiving coil 30 initially moves closer to the transmitting coil 24 from a maximum distance in which the wireless charging device 16 is able to charge the wirelessly chargeable battery 14, the voltage induced in the wirelessly chargeable battery 14 may increase while the expected power loss of the wirelessly chargeable battery 14 decreases. However, at some point during continued movement of the receiving coil 30 towards the transmitting coil 24, Eddy currents may be induced in metal components of the wirelessly chargeable battery 14 that increase the expected power loss of the wirelessly chargeable battery 14. Accordingly, the voltage induced in the wirelessly chargeable battery 14 may increase while the expected power loss of the wirelessly chargeable battery 14 may increase, resulting in a U-shaped waveform.

The calibration data stored in the non-volatile storage 54A of the battery controller 42A may be determined by measuring an electrical loss of the wirelessly chargeable battery 14 when the wirelessly chargeable battery 14 is in the foreign object detection configuration and is placed adjacent the charging surface 18 of the wireless charging device 16 without a foreign object 12 being present in varied positions such that the distance between the receiving coil 30 and the transmitting coil 24 is varied. In particular, for each position of the wirelessly chargeable battery 14 relative to the wireless charging device 16, a voltage induced in the wirelessly chargeable battery 14 by the wireless charging device 16, an electrical characteristic of the electrical load 46, an electrical characteristic of the power supply signal output by the power supply 20, and an electrical loss of the wireless charging device 16 may be determined. As described above, the electrical loss of the wireless charging device 16 may be stored as calibration data in the non-volatile storage 54B of the charger controller 42B, and the other data may be measured by the controllers 42. An electrical loss of the wirelessly chargeable battery 14 may then be determined based on the data. For instance, one of the controllers 42 may be configured to subtract the electrical characteristic of the electrical load 46 and the electrical loss of the wireless charging device 16 from the electrical characteristic of the power supply signal to determine the electrical loss of the wirelessly chargeable battery 14 for the current position of the wirelessly chargeable battery 14 relative to the wireless charging device 16.

The controllers 42 may thus generate a calibration sample 406 for each position of the wirelessly chargeable battery 14 relative to the wireless charging device 16, each calibration sample 406 including a measured voltage induced in the wirelessly chargeable battery 14 by the wireless charging device 16 when no foreign object 12 is present and a corresponding electrical loss of the wirelessly chargeable battery 14. The calibration data for determining an expected electrical loss of the wirelessly chargeable battery 14 based on a measured voltage induced in the wirelessly chargeable battery 14 may then be determined based on the calibration samples 406.

For instance, the controllers 42 may be configured to communicate the calibration samples 406 to a test fixture, which may then be configured to apply a curve fitting algorithm, such as a non-linear regression, to the calibration samples 406 to generate a function 404. The test fixture may then generate calibration data indicating the function 404, and communicate such calibration data to the battery controller 42A to be stored in the non-volatile storage 54A of the battery controller 42A. During subsequent foreign object detection cycles, the battery controller 42A may be configured to apply the measured voltage induced in the wirelessly chargeable battery 14 to the function 404 indicated by the calibration data to determine an expected electrical loss of the wirelessly chargeable battery 14. As a further example, the controllers 42 and/or a test fixture may be configured to generate a lookup table including the calibration samples 406 or samples taken from the determined function 404, and to store calibration data indicating the lookup table in the non-volatile storage 54A of the battery controller 42A. During subsequent foreign object detection cycles, the battery controller 42A may be configured to interpolate an expected electrical loss of the wirelessly chargeable battery 14 from the indicated lookup table based on the measured voltage induced in the wirelessly chargeable battery 14.

In some examples, at least one of the controllers 42 of the wireless charging system 10 may be configured to adjust the calibration data, such as a function 404 indicated by the calibration data, at run time, such as based on electrical characteristics of the wireless charging system 10 measured at run time. For instance, at least one of the controllers 42, such as the controller 42B, may be configured to adjust the function 404 responsive to determining that the supply voltage v_{supply} of the power supply signal differs from the supply voltage used to generate the calibration data. As another example, at least one of the controllers 42 may be configured to adjust the function 404 responsive to determining that an inductance of the receiving coil 30 and/or the transmitting coil 24 varies from that used to determine the calibration data. As a further example, at least one of the controllers 42, such as the controller 42A, may be configured to adjust the function 404 based on a measured temperature of the wirelessly chargeable battery 14. To this end, the sensors 40A of the battery control circuit 36 may also include a temperature sensor configured to generate data indicative of the temperature of the wirelessly chargeable battery 14.

In block 320, the data determined by the controllers 42 may be consolidated at one of the controllers 42, such as using the communications devices 44. For instance, the charger controller 42B may be configured to communicate the electrical characteristic of the power supply signal output by the power supply 20 and the electrical loss of the wireless charging device 16 to the battery controller 42A. Alternatively, the battery controller 42A may be configured to communicate data indicating the expected electrical loss of the wirelessly chargeable battery 14 and the electrical characteristic of the electrical load 46 to the charger controller 42B. For instance, the battery controller 42A may be configured to communicate each of the expected electrical loss of the wirelessly chargeable battery 14 and the electrical characteristic of the electrical load 46 to the charger controller 42B, or may be configured to communicate a sum of the expected electrical loss of the wirelessly chargeable battery 14 and the electrical characteristic of the electrical load 46 to the charger controller 42B.

In block 322, an expected electrical consumption of the wireless charging system 10 may be determined based on the consolidated data. More particularly, the controller 42 in which the data has been consolidated may be configured to determine the expected electrical consumption of the wireless charging system 10 based on the electrical loss of the wireless charging device 16, the expected electrical loss of the wirelessly chargeable battery 14, and the electrical characteristic of the fixed electrical load 46. For instance, the controller 42 may be configured to sum these items to determine the expected electrical consumption of the wireless charging system 10. As previously described, the expected electrical consumption of the wireless charging system 10 may not include any electrical loss corresponding to a foreign object 12 proximate the wireless charging device 16.

In block 324, an actual electrical consumption of the wireless charging system 10 may be compared to the expected electrical consumption of the wireless charging system 10. In particular, the controller 42 in which the data has been consolidated may be configured to determine a difference between the actual electrical consumption of the wireless charging system 10 and the expected electrical consumption of the wireless charging system 10. As previously described, the measured electrical characteristic of the power supply signal may be used as the actual electrical consumption of the wireless charging system 10.

In alternative examples, the actual electrical consumption of the wireless charging system 10 may be based on both the determined electrical characteristic of the power supply signal output by the power supply 20 and the determined electrical loss of the wireless charging device 16. For instance, the actual electrical consumption of the wireless charging system 10 may be set to the sum of these two values, which may correspond to the transmission power of the wireless charging device 16. In this case, the expected electrical consumption of the wireless charging system 10 may be based on the determined expected electrical loss of the wireless battery 14 and the determined electrical characteristic of the electrical load 46. For instance, the expected electrical consumption of the wireless charging system 10 may be set to the sum of these two values, which may correspond to an expected electrical consumption of the wirelessly chargeable battery 16. Similar to previous examples, the actual electrical consumption of the wireless charging system 10 may correspond to actual electrical consumption by the wirelessly chargeable battery 14 and by a foreign object 12, if present, and the expected electrical consumption of the wireless charging system 10 may correspond to an expected electrical consumption of the wirelessly chargeable battery 14 assuming a foreign object 12 is not present.

In these alternative examples, the battery controller 42A may be configured to determine the expected electrical consumption of the wireless charging system 10 based on the data determined by the battery controller 42A, namely the expected electrical loss of the wirelessly chargeable battery 14 and the electrical characteristic of the electrical load 46, and the charger controller 42B may be configured to determine the actual electrical consumption of the wireless charging system 10 based on the data determined by the charger controller 42B, namely the electrical characteristic of the power supply signal output by the power supply 20 and the electrical loss of the wireless charging device 16. In particular, each controller 42 may be configured to sum its determined data. Thereafter, to consolidate data in block 320, the battery controller 42A may be configured to communicate the expected electrical consumption of the wireless charging system 10 to the charger controller 42B, or the charger controller 42B may be configured to communicate the actual electrical consumption of the wireless charging system 10 to the battery controller 42A. Alternatively, one of these controllers 42 may be configured to communicate its determined data items to the other controller 42, which may then perform the summations for determining the actual and expected electrical consumptions. Thereafter, in block 324, the controller 24 in which the data has been consolidated may then be configured to compare the actual electrical consumption of the wireless charging system 10 to the expected electrical consumption of the wireless charging system 10, such as by determining a difference between the actual electrical consumption of the wireless charging system 10 and the expected electrical consumption of the wireless charging system 10.

Regardless of whether the electrical characteristic of the power supply is used as the actual electrical consumption of the wireless charging system 10, or the actual electrical consumption of the wireless charging system 10 is determined based on both the electrical characteristic of the power supply and the electrical loss of the wireless charging device 16, in block 326, a determination may be made of whether the difference determined in block 324 is greater than or equal to a predefined threshold value, such as by the controller 42 in which the data has been consolidated. The predefined threshold value may be stored as a constant value or in a lookup table in non-volatile storage 54 of the controller 42 in which the data has been consolidated. In some examples, the predefined threshold value may correspond to a maximum power P_{FO} that a foreign object 12 may dissipate without reaching an unsafe temperature. In some examples, referring to FIG. 4, the predefined threshold value may correspond to an average difference between the black line and the dotted line or a minimum difference between the black line and dotted line. In other examples, the predefined threshold value used in the comparison of block 326 may vary based on the electrical characteristics of the wireless charging system 10 measured at run time. For instance, referring to FIG. 4, the controller 42 may be configured to use a predefined threshold value that corresponds to a value between the black line and the dotted line at the induced voltage measured by the battery controller 42A, such as the median value.

Responsive to determining that the difference between the actual and expected electrical consumptions is not greater than the predefined threshold (“No” branch of block 326), in block 328, a charging cycle may be triggered. To this end, the battery controller 42A may be configured to engage the switch 48A and disengage the switch 48b such that the receiving coil 30 is coupled to the battery cells 38 and decoupled from the electrical load 46. Furthermore, the wireless charging device 16 may output a signal across the transmitting coil 24 for charging the battery cells 38. For instance, the battery controller 42A may be configured to communicate a current setpoint to the voltage regulator 34 that indicates a target current for the load current i_{load}. For example, the target current may be 1.4 amps. Responsive to the charging cycle being triggered, the voltage regulator 34 may be configured to draw a current from the wireless charging device 16 that enables the voltage regulator 34 to provide the target current to the battery cells 38.

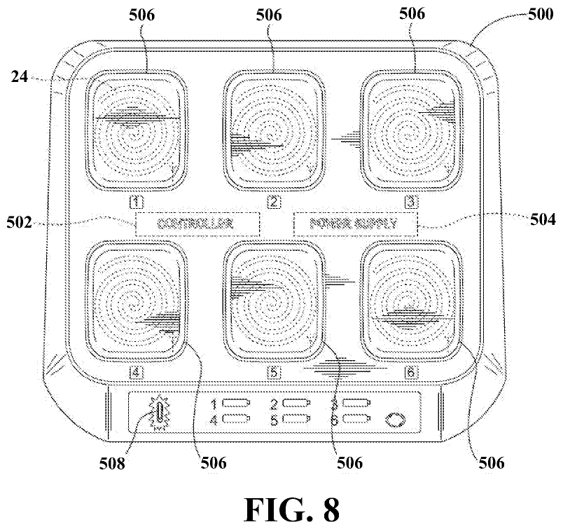

Alternatively, responsive to determining that the difference between the actual and expected electrical consumptions is greater than the predefined threshold (“Yes” branch of block 326), in block 330, a determination may be made that a foreign object 12 is proximate the wireless charging device 16. Thereafter, in block 332, the transmitting coil 24 may be deactivated. In particular, the charger controller 42B may be configured to prevent the DC/AC converter 26 from outputting a power supply signal across the transmitting coil 24 for charging the battery cells 38. In block 334, an alarm of the wireless charging system 10 may be triggered. The alarm may be an auditory, visual, or tactile alarm. For instance, the wireless charging device 16 may include a speaker configured to emit an auditory alarm. The wireless charging device 16 may also include light emitting device, such as the light emitting device 508 shown in FIG. 8, configured to emit light in response to the detection of a foreign object 12. The wireless charging device 16 may further include a vibrating motor configured to vibrate in response to detection of a foreign object 12.

Responsive to triggering an alarm in block 334, or to triggering a charging cycle in block 328, the method 300 may return to block 302 for continued monitoring for the one or more predefined events. In addition to the wirelessly chargeable battery 14 being positioned proximate the wireless charging device 16, the one or more predefined events monitored for by the wireless charging system 10 may include a predefined passage of time elapsing since performance of the last foreign object detection cycle. For example, the wireless charging system 10 may be configured to trigger a foreign object detection cycle every five minutes from a last foreign object detection cycle performed by the wireless charging system 10.

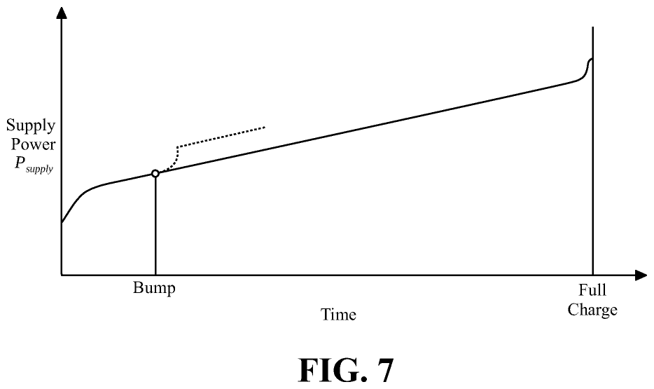

In some examples, the one or more predefined events monitored for by the wireless charging system 10 may also include a bump detection event. As described above, during charging cycles, the charger controller 42B may be configured to implement a constant current charging technique in which a constant load current i_{load} is provided for charging the battery cells 38. As the battery cells 38 are charged, however, the cell voltage may increase, which may increase the effective impedance of the battery cells 38 and correspondingly cause the load current i_{load} to decrease. In response, the wirelessly chargeable battery 14, or more particularly the voltage regulator 34, may be configured to draw additional current from the wireless charging device 16 to maintain the load current i_{load} at the target level. Correspondingly, the supply power P_{supply} and the supply current i_{supply} may increase. Referring to FIG. 7, the solid line illustrates a power curve showing supply power P_{supply} over time to charge the wirelessly chargeable battery 14 with a constant load current i_{load} that may be implemented by the wireless charging system 10.

Thus, the supply power P_{supply} and supply current i_{supply} of the power supply signal output by the power supply 20 may increase over the charging cycles to maintain a constant load current i_{load} to the battery cells 38. However, the supply power P_{supply} and supply current i_{load} of the power supply signal may also increase responsive to a bump of the wireless charging system 10 that causes a foreign object 17 to shift into a position where it absorbs more power P_{FO} from the wireless charging system 10, and thus increases the power consumption of the wireless charging system 10. Referring to FIG. 7, the dotted line illustrates a change in the supply power P_{supply} that may occur responsive to a bump event.

Thus, during charging cycles, the charger controller 42B may be configured to monitor an electrical characteristic of the power supply signal provided by the wireless charging device 16, and to determine occurrence of a bump event based on the monitoring of electrical characteristic. For instance, the electrical characteristic may be the supply power P_{supply} of the power supply signal or the supply current i_{supply} of the power supply signal output by the power supply 20. The charger controller 42B may be configured to continuously track the difference between a current level of the electrical characteristic and an initial level of the electrical characteristic at the start of the current charging cycle, and to determine whether the difference is greater than or equal to a predefined threshold value. The predefined threshold value may correspond to a predefined increase in an amount of power consumption of the wireless charging system 10. As one example, the predefined increase may be 400 milliwatts. In other words, the charger controller 42B may be configured to determine occurrence of a predefined event responsive to the supply power P_{supply} increasing by 400 milliwatts since a last foreign object detection cycle.

Responsive to detection of at least one of the one or more predefined events (“Yes” branch of block 302), in block 304, another foreign object detection cycle may be triggered. Thus, responsive to the wirelessly chargeable battery 14 being positioned proximate the wireless charging device 16, the wireless charging system 10 may be configured to perform object detection cycles interspaced by charging cycles in which the wireless charging device 16 charges the wirelessly chargeable battery 14. In each of the foreign object detection cycles, the wireless charging system 10 may be configured to refrain from charging the battery cells 38, and to determine whether a foreign object 12 is proximate the wireless charging device 16.

FIG. 8 illustrates a wireless charging device 500 for charging several wirelessly chargeable batteries 14 at a same time. More particularly, the wireless charging device 500 may include a controller 502, a power supply 504, and several charging bays 506. Each charging bay 506 may include a transmitting coil 24 for providing power to the receiving coil 30 of a wirelessly chargeable battery 14 disposed in the charging bay 506. The transmitting coil 24 of each charging bay 506 may be coupled to the power supply 504, such as through a DC/AC converter. The controller 502 and power supply 504 may mirror and be configured to perform the same functions as the power supply 20 and the charger controller 42B of the wireless charging device 16 described above, but for each charging bay 506. In other words, the controller 502 may be configured to facilitate performance of charging cycles and foreign object detection cycles for each charging bay 506, as described above.

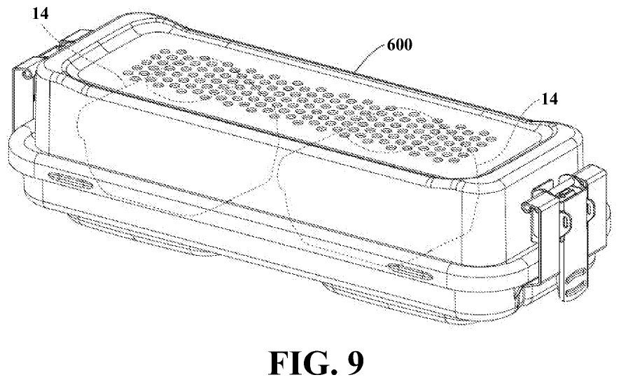

The wireless charging device 500 may also be configured to charge wirelessly chargeable batteries 14 contained in a sterilizable container disposed on the wireless charging device 500, such as the sterilizable container 600 shown in FIG. 9. In particular, one or multiple wirelessly chargeable batteries 14 may be sterilized and thereafter placed in the sterilizable container 600, which may also be sterilized (e.g., via an autoclave) and retain a sterile state of a volume contained therein. In other words, the sterilizable container 600 may provide a microbial barrier such that the contents within the sterilizable container 600 are maintained in a sterile state until the sterilizable container 600 has been opened.

Alternatively, the wirelessly chargeable batteries 14 may be placed within the sterilizable container 600 prior to sterilization. The sterilizable container 600 may then be sterilized in an autoclave process (or other suitable sterilization process) while the wirelessly chargeable batteries 14 remain inside the sterilizable container 600. Thus, the wirelessly chargeable batteries 14 and the sterilizable container 600 may be sterilized together and a volume within the sterilizable container 600 may be sterilized or maintained in a sterile state.

After using either of the above methods to sterilize the wirelessly chargeable batteries 14, the sterilizable container 600 may be carried or otherwise transported to a desired location of use while maintaining the sterile state of wirelessly chargeable batteries 14 and the sterile volume. For instance, the sterilizable container 600 may then be disposed on the wireless charging device 500 such that each wirelessly chargeable battery 14 placed in the sterilizable container 600 is disposed above the transmitting coil 24 a different charging bay 506. As such, the wireless charging device 500 may provide charging power to the wirelessly chargeable batteries 14 while the wirelessly chargeable batteries 14 remain microbially sealed within sterile volume. Each wirelessly chargeable battery 14 may also communicate with the wireless charging device 500 while the wirelessly chargeable battery 14 remains in the sterile volume to obtain battery operational data, battery state data, and/or any other suitable data described herein. While the wirelessly chargeable battery 14 is being transported to the wireless charging device 500, the wirelessly chargeable battery 14 and its internal components may be in a low power state.

In another instance, the wirelessly chargeable batteries 14 may be placed in the sterilizable container 600 prior to sterilization, and the sterilizable container 600 may be placed within a proximity of the wireless charging device 500 such that the wirelessly chargeable batteries 14 receive charging power while the sterilizable container 600 and the wirelessly chargeable batteries 14 are in the non-sterile state. In such an instance, after the wirelessly chargeable batteries 14 receive charging power from the wireless charging device 500, the sterilizable container 600 and the wirelessly chargeable batteries 14 may be sterilized in an autoclave or other sterilization process such that the wirelessly chargeable batteries 14 are stored in a sterile and charged state until the sterilizable container 600 is opened. Alternatively, the wirelessly chargeable battery 14 may be charged using the wireless charging device 500, and then be disposed into the sterilizable container 600 and sterilized.

Rather than the sterilizable container 600, the wirelessly chargeable batteries 14 may be disposed in blue wrap, sterilized, and charged using any of the above methods. Thus, the wirelessly chargeable batteries 14 may be charged through the blue wrap while being maintained in a sterile state.

It should be noted that the wirelessly chargeable battery 14 may be replaced with any power receiving device configured to receive power and store electrical charge. For example, the power receiving device may be a surgical tool configured to store electrical charge. The power receiving device may also be a refrigerator configured to store electrical charge or a light emitting device configured to store electrical charge.

Several example implementations have been discussed in the foregoing description. However, the examples discussed herein are not intended to be exhaustive or limit the invention to any particular form. The terminology that has been used herein is intended to be in the nature of words of description rather than of limitation. Many modifications and variations are possible in light of the above teachings and the invention may be practiced otherwise than as specifically described.

Examples of the disclosure can be described with reference to the following numbered CLAUSES, with specific features laid out in dependent clauses:

### CLAUSES

1. A system for detecting a foreign object proximate a wireless charging device, the system comprising:

a wirelessly chargeable battery comprising:
a receiving coil for receiving power from the wireless charging device when the receiving coil is proximate the wireless charging device,
one or more battery cells, and
an electrical load; and

at least one controller configured to switch the wirelessly chargeable battery between a first configuration in which the receiving coil is coupled to the one or more battery cells for charging the one or more battery cells and is decoupled from the electrical load, and a second configuration in which the receiving coil is coupled to the electrical load for supplying power to the electrical load and is decoupled from the one or more battery cells, the at least one controller being configured to:
measure a voltage induced in the wirelessly chargeable battery by the wireless charging device,
determine, as a first electrical characteristic, an expected electrical loss of the wirelessly chargeable battery based on the measured voltage,
determine a second electrical characteristic of the electrical load when the wirelessly chargeable battery is in the second configuration, and
determine whether a foreign object is proximate the wireless charging device based on the first and second electrical characteristics.

2. The system of clause 1, wherein the first electrical characteristic is an expected power loss of the wirelessly chargeable battery, and the second electrical characteristic is a power dissipated by the electrical load.

3. The system of clause 1, wherein the first electrical characteristic is an expected current loss of the wirelessly chargeable battery, and the second electrical characteristic is a current through the electrical load.

4. The system of any one of clauses 1-3, wherein the wirelessly chargeable battery comprises:

a voltage rectifier coupled to the receiving coil and configured to receive a first voltage from the receiving coil and generate a second voltage from the first voltage; and

a voltage regulator coupled to the voltage rectifier and configured to receive the second voltage from the voltage rectifier and generate a third voltage from the second voltage,

wherein the one or more battery cells are configured to receive the third voltage from the voltage regulator when the wirelessly chargeable battery is in the first configuration and the electrical load is configured to receive the third voltage from the voltage regulator when the wirelessly chargeable battery is in the second configuration, and

wherein the measured voltage is the second voltage.

5. The system of any one of clauses 1-4, wherein the wirelessly chargeable battery comprises a non-volatile storage device storing calibration data specific to the wirelessly chargeable battery, and the at least one controller is configured to determine the first electrical characteristic based on the measured voltage and the calibration data.

6. The system of clause 5, wherein the calibration data indicates varying expected electrical losses of the wirelessly chargeable battery that correspond to varying positions the wirelessly chargeable battery relative to a wireless charging device, each of the expected electrical losses being associated with a different voltage within the calibration data, and the at least one controller is configured to determine the first electrical characteristic based on the measured voltage and the calibration data by being configured to determine one of the expected electrical losses indicated in the calibration data that is associated with the measured voltage within the calibration data.

7. The system of any one of clauses 1-6, wherein the electrical load comprises at least one resistor sized to dissipate a same amount of power as the one or more battery cells when the one or more battery cells are substantially fully charged.

8. The system of clause 7, wherein the at least one resistor has a combined resistance of 8.3 ohms.

9. The system of any one of clauses 1-8, wherein the at least one controller is configured to:

determine, as a third electrical characteristic, an expected electrical loss of the wireless charging device;

determine a fourth electrical characteristic of a power supply signal produced by the wireless charging device; and

determine whether the foreign object is proximate the wireless charging device based on the first, second, third, and fourth electrical characteristics.

10. The system of clause 9, wherein the third electrical characteristic is an expected power loss of the wireless charging device, and the fourth electrical characteristic is a supply power provided by the power supply signal.

11. The system of clause 9, wherein the third electrical characteristic is an expected current loss of the wireless charging device, and the fourth electrical characteristic is a supply current of the power supply signal.

12. The system of any one of clauses 9-11, wherein the wirelessly chargeable battery comprises a first communications device for communicating with a second communications device of the wireless charging device when the wirelessly chargeable battery is proximate the wireless charging device, and the at least one controller comprises a battery controller integrated with the wirelessly chargeable battery and configured to:

measure the voltage induced in the wirelessly chargeable battery by the wireless charging device;

determine the first electrical characteristic based on the measured voltage;

measure the second electrical characteristic;

receive the third and fourth electrical characteristics from the wireless charging device through the first and second communications devices; and

determine whether the foreign object is proximate the wireless charging device based on the first, second, third, and fourth electrical characteristics.

13. The system of clause 12, further comprising the wireless charging device, wherein the at least one controller comprises a charger controller integrated with the wireless charging device and configured to:

determine the third electrical characteristic;

measure the fourth electrical characteristic; and

communicate the third and fourth electrical characteristics to the battery controller through the first and second communications devices.

14. The system of any one of clauses 9-11, wherein the wirelessly chargeable battery comprises a first communications device for communicating with a second communications device of the wireless charging device when the wirelessly chargeable battery is proximate the wireless charging device, and the at least one controller comprises a battery controller integrated with the wirelessly chargeable battery and configured to:

measure the voltage induced in the wirelessly chargeable battery by the wireless charging device;

determine the first electrical characteristic based on the measured voltage;

measure the second electrical characteristic; and

communicate the first and second electrical characteristics to the wireless charging device through the first and second communications devices.

15. The system of clause 14, further comprising the wireless charging device, wherein the at least one controller comprises a charger controller integrated with the wireless charging device and configured to:

receive the first and second electrical characteristics;

determine the third electrical characteristic;

measure the fourth electrical characteristic; and

determine whether the foreign object is proximate the wireless charging device based on the first, second, third, and fourth electrical characteristics.

16. The system of any one of clauses 9-15, wherein the wireless charging device comprises a non-volatile storage device storing calibration data indicating the third electrical characteristic, and the at least one controller is configured to determine the third electrical characteristic by being configured to read the calibration data from the non-volatile storage device.

17. The system of any one of clauses 9-16, wherein the at least one controller is configured to determine whether the foreign object is proximate the wireless charging device based on the first, second, third, and fourth electrical characteristics by being configured to:

determine, as a fifth electrical characteristic, an expected electrical consumption of the system based on the first, second, and third electrical characteristics;

determine whether a difference between the fifth electrical characteristic and the fourth electrical characteristic is greater than or equal to a predefined threshold value; and

responsive to determining that the difference between the fifth electrical characteristic and the fourth electrical characteristic is greater than or equal to the predefined threshold value, determine that a foreign object is proximate the wireless charging device.

18. The system of any one of clauses 1-17, wherein the at least one controller is configured to:

responsive to determining that a foreign object is not proximate the wireless charging device, trigger a charging cycle; and

responsive to determining that a foreign object is proximate the wireless charging device, disable charging of the wirelessly chargeable battery.

19. The system of any one of clauses 1-18, wherein responsive to the wirelessly chargeable battery being positioned proximate the wireless charging device, the at least one controller is configured to perform foreign object detection cycles interspaced by charging cycles, wherein in each of the foreign object detection cycles, the at least one controller is configured to:

switch the wirelessly chargeable battery to the second configuration;

measure the voltage induced in the wirelessly chargeable battery by the wireless charging device;

determine the first electrical characteristic based on the measured voltage;

determine the second electrical characteristic;

determine whether a foreign object is proximate the wireless charging device based on the first and second electrical characteristics;

responsive to determining that a foreign object is not proximate the wireless charging device, trigger one of the charging cycles; and

responsive to determining that a foreign object is proximate the wireless charging device, disable charging of the wirelessly chargeable battery, and

wherein in each of the charging cycles, the at least one controller is configured to switch the wirelessly chargeable battery to the first configuration.

20. The system of clause 19, wherein the at least one controller is configured to trigger each of the foreign object detection cycles responsive to detection of at least one of one or more predefined events.

21. The system of clause 20, wherein the one or more predefined events comprise the wirelessly chargeable battery being positioned proximate the wireless charging device.

22. The system of clauses 20 or 21, wherein the one or more predefined events comprise a predefined passage of time from a last foreign object detection cycle.

23. The system of any one of clauses 20-22, wherein the one or more predefined events comprise a predefined increase in power supplied by the wireless charging device since a last foreign object detection cycle.

24. A wireless charging device comprising:

a transmitting coil for transmitting power to a wirelessly chargeable battery when the wirelessly chargeable battery is proximate the transmitting coil;

a power supply coupled to the transmitting coil and configured to generate a power supply signal for powering the transmitting coil; and

at least one controller configured to:
determine a first electrical characteristic of the power supply signal,
determine, as a second electrical characteristic, an expected electrical loss of the wireless charging device, and
determine whether a foreign object is proximate the wireless charging device based on the first and second electrical characteristics.

25. The wireless charging device of clause 24, wherein the first electrical characteristic is a supply power provided by the power supply signal, and the second electrical characteristic is an expected power loss of the wireless charging device.

26. The wireless charging device of clause 24, wherein the first electrical characteristic is a supply current of the power supply signal, and the second electrical characteristic is an expected current loss of the wireless charging device.

27. The wireless charging device of any one of clauses 24-26, further comprising a first communications device for communicating with a second communications device of the wirelessly chargeable battery when the wirelessly chargeable battery is proximate the wireless charging device, and the at least one controller is configured to:

determine the first and second electrical characteristics;

receive, as a third electrical characteristic, an expected electrical loss of the wirelessly chargeable battery and a fourth electrical characteristic of an electrical load of the wirelessly chargeable battery from the wirelessly chargeable battery through the first and second communications devices; and

determine whether the foreign object is proximate the wireless charging device based on the first, second, third, and fourth electrical characteristics.

28. The wireless charging device of clause 27, wherein the third electrical characteristic is an expected power loss of the wirelessly chargeable battery, and the fourth electrical characteristic is a power dissipated by the electrical load.

29. The wireless charging device of clause 27, wherein the third electrical characteristic is an expected current loss of the wirelessly chargeable battery, and the fourth electrical characteristic is a current through the electrical load.

30. The wireless charging device of any one of clauses 24-29, further comprising a non-volatile storage device storing calibration data indicating the second electrical characteristic, and the at least one controller is configured to determine the second electrical characteristic by being configured to read the calibration data from the non-volatile storage device.

31. The wireless charging device of any one of clauses 24-30, wherein the at least one controller is configured to determine whether the foreign object is proximate the wireless charging device based on the first, second, third, and fourth electrical characteristics by being configured to:

determine, as a fifth electrical characteristic, an expected electrical consumption of the system based on the second, third, and fourth electrical characteristics;

determine whether a difference between the fifth electrical characteristic and the first electrical characteristic is greater than or equal to a predefined threshold value; and

responsive to determining that the difference between the fifth electrical characteristic and the first electrical characteristic is greater than or equal to the predefined threshold value, determine that the foreign object is proximate the wireless charging device.

32. The wireless charging device of any one of clauses 24-31, wherein the at least one controller is configured to, responsive to determining that a foreign object is proximate the wireless charging device, disable charging of the wirelessly chargeable battery.

33. The wireless charging device of any one of clauses 24-32, wherein, responsive to the wirelessly chargeable battery being positioned proximate the wireless charging device, the at least one controller is configured to perform foreign object detection cycles interspaced by charging cycles, wherein in each of the foreign object detection cycles, the at least one controller is configured to:

determine the first electrical characteristic of the power supply signal;

determine the second electrical characteristic;

determine whether a foreign object is proximate the wireless charging device based on the first and second electrical characteristics;

responsive to determining that a foreign object is not proximate the wireless charging device, trigger one of the charging cycles; and

responsive to determining that a foreign object is proximate the wireless charging device, disable charging.

34. The wireless charging device of clause 33, wherein the at least one controller is configured to trigger each of the foreign object detection cycles responsive to detection of at least one of one or more predefined events.

35. The wireless charging device of clause 34, wherein the one or more predefined events comprises the wirelessly chargeable battery being positioned proximate the wireless charging device.

36. The wireless charging device of clauses 34 or 35, wherein the one or more predefined events comprise a predefined passage of time from a last foreign object detection cycle.

37. The wireless charging device of any one of clauses 34-36, wherein the one or more predefined events comprise a predefined increase in power supplied by the wireless charging device since a last foreign object detection cycle.

38. A method for detecting a foreign object proximate a wireless charging system including a wireless charging device and a wirelessly chargeable battery including a receiving coil for receiving power from the wireless charging device when the receiving coil is proximate the wireless charging device, one or more battery cells, and an electrical load, the method comprising: switching the wirelessly chargeable battery to a first configuration in which the receiving coil is coupled to the electrical load for supplying power to the electrical load and is decoupled from the one or more battery cells;

measuring a voltage induced in the wirelessly chargeable battery by the wireless charging device;

determining, as a first electrical characteristic, an expected electrical loss of the wirelessly chargeable battery based on the measured voltage;

determining a second electrical characteristic of the electrical load when the wirelessly chargeable battery is in the first configuration; and

determining whether a foreign object is proximate the wireless charging device based on the first and second electrical characteristics.

39. The method of clause 38, wherein the wirelessly chargeable battery comprises a non-volatile storage device storing calibration data specific to the wirelessly chargeable battery, and determining the first electrical characteristic based on the measured voltage comprises determining the first electrical characteristic based on the measured voltage and the calibration data.

40. The method of clauses 38 or 39, further comprising:

determining, as a third electrical characteristic, an expected electrical loss of the wireless charging device;

determining a fourth electrical characteristic of a power supply signal produced by the wireless charging device; and

determining whether the foreign object is proximate the wireless charging device based on the first, second, third, and fourth electrical characteristics.

41. The method of clause 40, wherein the wirelessly chargeable battery comprises a first communications device for communicating with a second communications device of the wireless charging device when the wirelessly chargeable battery is proximate the wireless charging device, and further comprising:

measuring, by the wirelessly chargeable battery, the voltage induced in the wirelessly chargeable battery by the wireless charging device;

determining, by the wirelessly chargeable battery, the first electrical characteristic based on the measured voltage;

receiving, by the wirelessly chargeable battery, the third and fourth electrical characteristics from the wireless charging device through the first and second communications devices; and

determining, by the wirelessly chargeable battery, whether the foreign object is proximate the wireless charging device based on the first, second, third, and fourth electrical characteristics.

42. The method of clause 41, further comprising:

determining, by the wireless charging device, the third electrical characteristic;

measuring, by the wireless charging device, the fourth electrical characteristic; and

communicating, by the wireless charging device, the third and fourth electrical characteristics to the wirelessly chargeable battery through the first and second communications devices.

43. The method of clause 40, wherein the wirelessly chargeable battery comprises a first communications device for communicating with a second communications device of the wireless charging device when the wirelessly chargeable battery is proximate the wireless charging device, and further comprising:

measuring, by the wirelessly chargeable battery, the voltage induced in the wirelessly chargeable battery by the wireless charging device;

determining, by the wirelessly chargeable battery, the first electrical characteristic based on the measured voltage;

measure, by the wirelessly chargeable battery, the second electrical characteristic; and

communicating, by the wirelessly chargeable battery, the first and second electrical characteristics to the wireless charging device through the first and second communications devices.

44. The method of clause 43, further comprising:

receiving, by the wireless charging device, the first and second electrical characteristics through the first and second communications devices;

determining, by the wireless charging device, the third electrical characteristic;

measuring, by the wireless charging device, the fourth electrical characteristic; and

determining, by the wireless charging device, whether the foreign object is proximate the wireless charging device based on the first, second, third, and fourth electrical characteristics.

45. The method of any one of clauses 40-44, wherein the wireless charging device comprises a non-volatile storage device storing calibration data indicating the third electrical characteristic, and determining the third electrical characteristic comprises reading the calibration data from the non-volatile storage device.

46. The method of any one of clauses 40-45, wherein determining whether the foreign object is proximate the wireless charging device based on the first, second, third, and fourth electrical characteristics comprises:

determining, as a fifth electrical characteristic, an expected electrical consumption of the system based on the first, second, and third electrical characteristics;

determining whether a difference between the fifth electrical characteristic and the fourth electrical characteristic is greater than a predefined threshold value; and

responsive to determining that difference between the fifth electrical characteristic and the fourth electrical characteristic is greater than the predefined threshold value, determining that the foreign object is proximate the wireless charging device.

47. The method of any one of clauses 38-46, further comprising:

responsive to determining that a foreign object is not proximate the wireless charging device, switching the wirelessly chargeable battery to a second configuration in which the receiving coil is coupled to the one or more battery cells for charging the one or more battery cells and is decoupled from the electrical load; and

responsive to determining that a foreign object is proximate the wireless charging device, disabling charging of the wirelessly chargeable battery.

48. The method of any one of clauses 38-47, further comprising, responsive to the wirelessly chargeable battery being positioned proximate the wireless charging device, performing foreign object detection cycles interspaced by charging cycles, wherein each of the foreign object detection cycles comprises:

switching the wirelessly chargeable battery to the first configuration;

measuring the voltage induced in the wirelessly chargeable battery by the wireless charging device;

determining the first electrical characteristic based on the measured voltage;

determining the second electrical characteristic; and

determining whether a foreign object is proximate the wireless charging device based on the first and second electrical characteristics;

responsive to determining that a foreign object is not proximate the wireless charging device, triggering one of the charging cycles; and

responsive to determining that a foreign object is proximate the wireless charging device, disabling charging of the wirelessly chargeable battery,

wherein each of the charging cycles comprises switching the wirelessly chargeable battery to a second configuration in which the receiving coil is coupled to the one or more battery cells for charging the one or more battery cells and is decoupled from the electrical load.

49. The method of clause 48, further comprising:

monitoring for occurrence of one or more predefined events; and

triggering each of the foreign object detection cycles responsive to detection of at least one of the one or more predefined events.

50. The method of clause 49, further comprising triggering one of the foreign object detection cycles responsive to determining that the wirelessly chargeable battery has been positioned proximate the wireless charging device.

51. The method of clauses 49 or 50, further comprising triggering one of the foreign object detection cycles responsive to determining that a predefined period of time has elapsed from a last foreign object detection cycle.

52. The method of any one of clauses 49-51, further comprising triggering one of the foreign object detection cycles responsive to a predefined increase in power supplied by the wireless charging device since a last foreign object detection cycle.

53. A method for detecting a foreign object proximate a wireless charging device including a transmitting coil for transmitting power to a wirelessly chargeable battery when the wirelessly chargeable battery is proximate the transmitting coil and a power supply coupled to the transmitting coil and configured to generate a power supply signal for powering the transmitting coil, the method comprising:

determining a first electrical characteristic of the power supply signal,

determining, as a second electrical characteristic, an expected electrical loss of the wireless charging device, and

determining whether a foreign object is proximate the wireless charging device based on the first and second electrical characteristics.

54. The method of clause 53, wherein the wireless charging device comprises a first communications device for communicating with a second communications device of the wirelessly chargeable battery when the wirelessly chargeable battery is proximate the wireless charging device, and further comprising:

determining, by the wireless charging device, the first and second electrical characteristics,

receiving, by the wireless charging device, an expected electrical loss of the wirelessly chargeable battery as a third electrical characteristic and a fourth electrical characteristic of an electrical load of the wirelessly chargeable battery from the wirelessly chargeable battery through the first and second communications devices; and

determining, by the wireless charging device, whether the foreign object is proximate the wireless charging device based on the first, second, third, and fourth electrical characteristics.

55. The method of clauses 53 or 54, wherein the wireless charging device further includes a non-volatile storage device storing calibration data indicating the second electrical characteristic, and determining the second electrical characteristic comprises reading the calibration data from the non-volatile storage device.

56. The method of clause 54, wherein determining whether the foreign object is proximate the wireless charging device based on the first, second, third, and fourth electrical characteristics comprises:

determining, as a fifth electrical characteristic, an expected electrical consumption of the system based on the second, third, and fourth electrical characteristics;

determining whether a difference between the fifth electrical characteristic and the first electrical characteristic is greater than or equal to a predefined threshold value; and

responsive to determining that the difference between the fifth electrical characteristic and the first electrical characteristic is greater than or equal to the predefined threshold value, determining that the foreign object is proximate the wireless charging device.

57. The method of any one of clauses 53-56, further comprising, responsive to determining that a foreign object is proximate the wireless charging device, disabling charging of the wirelessly chargeable battery.

58. The method of any one of clauses 53-57, further comprising, responsive to the wirelessly chargeable battery being positioned proximate the wireless charging device, performing foreign object detection cycles interspaced by charging cycles, wherein each of the foreign object detection cycles comprises:

determining the first electrical characteristic of the power supply signal;

determining the second electrical characteristic;

determining whether a foreign object is proximate the wireless charging device based on the first and second electrical characteristics;

responsive to determining that a foreign object is not proximate the wireless charging device, triggering one of the charging cycles; and

responsive to determining that a foreign object is proximate the wireless charging device, disabling charging of the wirelessly chargeable battery.

59. The method of clause 58, further comprising:

monitoring for occurrence of one or more predefined events; and

triggering each of the foreign object detection cycles responsive to detection of at least one of the one or more predefined events.

60. The method of clauses 58 or 59, further comprising triggering one of the foreign object detection cycles responsive to determining that the wirelessly chargeable battery has been positioned proximate the wireless charging device.

61. The method of any one of clauses 58-60, further comprising triggering one of the foreign object detection cycles responsive to determining that a predefined period of time has elapsed from a last foreign object detection cycle.

62. The method of any one of clauses 58-61, further comprising triggering one of the foreign object detection cycles responsive to a predefined increase in power supplied by the wireless charging device since a last foreign object detection cycle.

1.-104. (canceled)

105. A wireless charging system for detecting foreign objects, the wireless charging system comprising:
a wireless charging device comprising a first controller configured to determine an actual electrical consumption of the wireless charging system; and
a wirelessly chargeable battery comprising:
a receiving coil for receiving power from the wireless charging device when the receiving coil is proximate the wireless charging device;
one or more battery cells;
an electrical load, wherein the wirelessly chargeable battery is in a charging configuration when the receiving coil is coupled to the one or more battery cells for charging the one or more battery cells and is decoupled from the electrical load, and wherein wirelessly chargeable battery is in a foreign object detection configuration when the receiving coil is coupled to the electrical load for supplying power to the electrical load and is decoupled from the one or more battery cells; and
a second controller configured to measure a voltage induced in the wirelessly chargeable battery by the wireless charging device and switch the wirelessly chargeable battery between the charging configuration and the foreign object detection configuration,
wherein the first controller, the second controller, or a combination of the first and second controllers, is configured to:
determine an expected electrical consumption of the wireless charging system based on the measured voltage; and
determine whether a foreign object is proximate the wireless charging system based on the expected and actual electrical consumptions.

106. The wireless charging system of claim 105, wherein the wireless charging device comprises:
a transmitting coil for transmitting power to the wirelessly chargeable battery; and
a power supply coupled to the transmitting coil and configured to generate a power supply signal for powering the transmitting coil,
wherein the first controller is configured to determine the actual electrical consumption of the wireless charging system by being configured to measure an electrical characteristic of the power supply signal.

107. The wireless charging system of claim 105, wherein the wirelessly chargeable battery comprises:
a voltage rectifier coupled to the receiving coil and configured to receive a first voltage from the receiving coil and generate a second voltage from the first voltage; and
a voltage regulator coupled to the voltage rectifier and configured to receive the second voltage from the voltage rectifier and generate a third voltage from the second voltage; and
wherein the one or more battery cells are configured to receive the third voltage from the voltage regulator, and
wherein the measured voltage induced in the wirelessly chargeable battery is the second voltage.

108. The wireless charging system of claim 105, wherein the electrical load comprises at least one resistor sized to dissipate an amount of power that is substantially equal to a maximum power directed to the one or more battery cells in the charging configuration.

109. The wireless charging system of claim 105, wherein the second controller is configured to:
determine, as a first electrical characteristic, an expected electrical loss of the wirelessly chargeable battery based on the measured voltage; and
determine, as a second electrical characteristic, an electrical characteristic of a signal sourced to the electrical load when the wirelessly chargeable battery is in the foreign object detection configuration,
wherein the expected electrical consumption of the wireless charging system is determined based on the first and second electrical characteristics.

110. The wireless charging system of claim 109, wherein the wirelessly chargeable battery comprises a non-volatile storage device storing calibration data specific to the wirelessly chargeable battery, and the second controller is configured to determine the first electrical characteristic based on the measured voltage and the calibration data.

111. The wireless charging system of claim 110, wherein the calibration data indicates varying expected electrical losses of the wirelessly chargeable battery that correspond to varying positions the wirelessly chargeable battery relative to a wireless charging device, each of the expected electrical losses being associated with a different voltage within the calibration data, and the second controller is configured to determine the first electrical characteristic based on the measured voltage and the calibration data by being configured to determine one of the expected electrical losses indicated in the calibration data that is associated with the measured voltage within the calibration data.

112. The wireless charging system of claim 109, wherein the wireless charging device comprises:
a transmitting coil for transmitting power to the wirelessly chargeable battery; and
a power supply coupled to the transmitting coil and configured to generate a power supply signal for powering the transmitting coil,
wherein the first controller is configured to:
measure an electrical characteristic of the power supply signal;
set the electrical characteristic of the power supply signal as the actual electrical consumption of the wireless charging system; and
determine, as a third electrical characteristic, an expected electrical loss of the wireless charging device,
wherein the expected electrical consumption of the wireless charging system is further determined based on the third electrical characteristic.

113. The wireless charging system of claim 112, wherein the wireless charging device comprises a first communications device, the wirelessly chargeable battery includes a second communications device for communicating with the first communications device when the wirelessly chargeable battery is proximate the wireless charging device, and the second controller is configured to:
receive the third electrical characteristic and the actual electrical consumption of the wireless charging system from the wireless charging device through the first and second communications devices;
determine the expected electrical consumption of the wireless charging system based on the first, second, and third electrical characteristics; and
determine whether a foreign object is proximate the wireless charging system based on the expected and actual electrical consumptions.

114. The wireless charging system of claim 112, wherein the wireless charging device comprises a first communications device, the wirelessly chargeable battery includes a second communications device for communicating with the first communications device when the wirelessly chargeable battery is proximate the wireless charging device, and the first controller is configured to:
receive data indicating the first and second electrical characteristics from the wirelessly chargeable battery through the first and second communications devices;
determine the expected electrical consumption of the wireless charging system based on the received data and third electrical characteristic; and
determine whether a foreign object is proximate the wireless charging system based on the expected and actual electrical consumptions.

115. The wireless charging system of claim 109, wherein the wireless charging device comprises:
a transmitting coil for transmitting power to the wirelessly chargeable battery; and
a power supply coupled to the transmitting coil and configured to generate a power supply signal for powering the transmitting coil,
wherein the first controller is configured to determine the actual electrical consumption of the wireless charging system by being configured to:
measure an electrical characteristic of the power supply signal;
determine, as a third electrical characteristic, an electrical loss of the wireless charging device; and
determine the actual electrical consumption of the wireless charging system based on the electrical characteristic of the power supply signal and the third electrical characteristic.

116. The wireless charging system of claim 115, wherein the wireless charging device comprises a first communications device, the wirelessly chargeable battery includes a second communications device for communicating with the first communications device when the wirelessly chargeable battery is proximate the wireless charging device, and the first controller is configured to:
receive the actual electrical consumption of the wireless charging system from the wireless charging device through the first and second communications devices;
receive data indicating the first and second electrical characteristics from the wirelessly chargeable battery through the first and second communications devices;
determine the expected electrical consumption of the wireless charging system based on the received data; and
determine whether a foreign object is proximate the wireless charging system based on the expected and actual electrical consumptions.

117. The wireless charging system of claim 112, wherein the wireless charging device comprises a non-volatile storage device storing calibration data indicating the electrical loss of the wireless charging device, and the first controller is configured to determine the electrical loss of the wireless charging device by being configured to read the calibration data from the non-volatile storage device.

118. The wireless charging system of claim 105, wherein the first controller or the second controller is configured to:
determine whether a difference between the actual electrical consumption and the expected electrical consumption is greater than or equal to a predefined threshold value; and
responsive to determining that the difference is greater than or equal to the predefined threshold value, determine that a foreign object is proximate the wireless charging system.

119. The wireless charging system of claim 105, wherein the first controller or the second controller is configured to:
responsive to determining that a foreign object is not proximate the wireless charging device, trigger a charging cycle; and
responsive to determining that a foreign object is proximate the wireless charging device, disable charging of the wirelessly chargeable battery.

120. A wirelessly chargeable battery for detecting foreign objects proximate a wireless charging system that includes the wirelessly chargeable battery and a wireless charging device that transmits power to the wirelessly chargeable battery when the wirelessly chargeable battery is proximate the wireless charging device, the wirelessly chargeable battery comprising:
a receiving coil for receiving power from the wireless charging device when the receiving coil is proximate the wireless charging device;
one or more battery cells;
an electrical load, wherein the wirelessly chargeable battery is in a charging configuration when the receiving coil is coupled to the one or more battery cells for charging the one or more battery cells and is decoupled from the electrical load, and wherein wirelessly chargeable battery is in a foreign object detection configuration when the receiving coil is coupled to the electrical load for supplying power to the electrical load and is decoupled from the one or more battery cells; and
a controller configured to:
measure a voltage induced in the wirelessly chargeable battery by the wireless charging device;
switch the wirelessly chargeable battery between the charging configuration and the foreign object detection configuration;
determine an expected electrical consumption of the wireless charging system based on the measured voltage; and
determine whether a foreign object is proximate the wireless charging system based on the expected electrical consumption and an actual electrical consumption of the wireless charging system.

121. A wirelessly charging system for detecting foreign objects, the wirelessly charging system comprising:
a wirelessly chargeable battery;
a wireless charging device including a transmitting coil for charging the wirelessly chargeable battery when the wirelessly chargeable battery is positioned proximate the transmitting coil; and
at least one controller configured to:
responsive to the wirelessly chargeable battery being positioned a first distance from the transmitting coil of the wireless charging device:
determine a first expected electrical consumption of the of the wireless charging system that corresponds to the first distance, and
determine whether a foreign object is proximate the wireless charging system based on the first expected electrical consumption; and
responsive to the wirelessly chargeable battery being positioned a second distance from the transmitting coil of the wireless charging device that differs from the first distance:
determine a second expected electrical consumption of the of the wireless charging system that corresponds to the second distance, and
determine whether a foreign object is proximate the wireless charging system based on the second expected electrical consumption.
